(19) United States
(12) Patent Application Publication
(10) Pub. No.: US 2024/0301331 A1
(43) Pub. Date: Sep. 12, 2024

(54) IMPROVEMENTS IN OR RELATING TO ORGANIC COMPOUNDS

(71) Applicant: GIVAUDAN SA, VERNIER (CH)

(72) Inventors: Evelyne CACLIN, Andresy (FR); Aurelie FERRY, Bouffemont (FR); Anne-Sylvie SELEZNEFF, Paris (FR); Sophie PERROT, Paris (FR); Nicolas ANORGA, Briscous (FR)

(21) Appl. No.: 18/262,114

(22) PCT Filed: Feb. 16, 2022
(86) PCT No.: PCT/EP2022/053796

§ 371 Date: Jul. 19, 2023

(30) Foreign Application Priority Data
Feb. 18, 2021 (GB) 2102267.8

(51) Int. Cl. C11D 3/50; C11D 3/37; C11D 17/00; C11D 17/08

(52) U.S. Cl. CPC C11D 3/505; C11D 3/3726; C11D 17/0013; C11D 17/0039; C11D 17/08

(57) ABSTRACT

Disclosed are an encapsulated composition comprising a plurality of core-shell microcapsules and a use of such an encapsulated composition for making a consumer product.

The present invention relates to an encapsulated composition comprising a plurality of core-shell microcapsules and a use of such an encapsulated composition for making a consumer product.

It is known to incorporate encapsulated functional materials in consumer products, such as household care, personal care and fabric care products. Functional materials include for example fragrances, flavors, cosmetic ingredients, biocides, substrate enhancers and nutraceuticals.

Microcapsules that are particularly suitable for delivery of such functional materials are core-shell microcapsules, wherein the core comprises the functional material and the shell is impervious or partially impervious to the functional material. Usually, these microcapsules are used in aqueous media and the encapsulated functional materials are hydrophobic. A broad selection of shell materials can be used, provided these shell materials are impervious or partially impervious to the encapsulated functional material.

Among the functional materials, fragrances are encapsulated for a variety of reasons. Microcapsules can isolate and protect the fragrances from external suspending media, such as consumer product bases, with which they may be incompatible or unstable in. They are also used to assist in the deposition of fragrance ingredients onto substrates, such as skin, hair, fabrics or hard household surfaces. Furthermore, they can act as a means of controlling the spatio-temporal release of the fragrance. These features provide enhanced olfactive benefits that are currently not achievable without microcapsules.

Thermosetting resins are common shell materials for such fragrance encapsulates. Core-shell microcapsules formed from aminoplast resins, polyurea resins, polyurethane resins, polyacrylate resins and combinations thereof are generally quite resistant to fragrance leakage when dispersed in aqueous suspending media, even in surfactant-containing media.

It is believed that thermosetting resins are especially suitable for fragrance microencapsulation because of the fact that such resins are highly cross-linked and form dense networks with mesh sizes in the order of the molecular size of the encapsulated ingredients.

By way of example, WO 2016/207180 A1 discloses aminoplast core-shell microcapsules. These microcapsules have excellent properties, both in manufacture and application.

However, nowadays consumers are increasingly concerned about using highly cross-linked materials, and especially of thermosetting resins, due to their slow degradation in the environment.

One approach to reduce the amount of cross-linked materials used is to minimize the level of core-shell microcapsules in a consumer product. However, at low levels, the olfactive performance of microcapsules comprising conventional encapsulated perfumes weakens in such a way that the consumer may not be able to perceive their benefit during the application of the product.

It is therefore a problem underlying the present invention to overcome the above-mentioned shortcomings in the prior art. In particular, it is a problem underlying the present invention to provide encapsulated compositions comprising a plurality of core-shell microcapsules, which can be used in consumer products in reduced amounts, while still providing the desired olfactive benefits.

In a first aspect, the present invention provides an encapsulated composition comprising a plurality of core-shell microcapsules. The core-shell microcapsules comprises a core and a shell surrounding the core. The core comprises a perfume composition. The perfume composition comprises at least 5 wt.-%, preferably at least 9 wt.-%, more preferably at least 12 wt.-%, based on the total weight of the perfume composition, of at least four, preferably at least five, more preferably at least six, performance driving perfume ingredients selected from the group consisting of ADOXAL (2,6,10-trimethylundec-9-enal); ALDEHYDE C 11 MOA (2-methyldecanal); ALDEHYDE C 11 UNDECYLENIC (undec-10-enal); ALDEHYDE ISO C 11 ((E)-undec-9-enal); AMBERKETAL (3,8,8,11a-tetramethyldodecahydro-1H-3,5a-epoxynaphtho[2,1-c]oxepine); AMBERMAX (1,3,4,5,6,7-hexahydro-3,1,1,5,5-pentamethyl-2H-2,4a-methanonaphthalene-8-ethanol); AMBER XTREM (decahydro-2,2,6,6,7,8,8-heptamethyl indenofuran); AMBROCENIDE ((4aR,5R,7aS,9R)-Octahydro-2,2,5,8,8,9a-hexamethyl-4H-4a,9-methanoazuleno[5,6-d]-1,3-dioxole); AZURONE (7-isopentyl-2H-benzo[b][1,4]dioxepin-3(4H)-one); BIGARYL (8-(sec-butyl)-5,6,7,8-tetrahydroquinoline); BUTYL QUINOLINE SECONDARY (2-(2-methylpropyl)quinoline); CARVACROL (5-isopropyl-2-methylphenol); CASSYRANE (5-tert-butyl-2-methyl-5-propyl-2H-furan); CETONE V ((E)-1-(2,6,6-trimethylcyclohex-2-en-1-yl)hepta-1,6-dien-3-one); CORPS PAMPLEMOUSSE ((4S)-4,7,7-trimethyl-6-thiabicyclo[3.2.1]octane); CRESYL METHYL ETHER PARA (1-methoxy-4-methylbenzene); CUMIN NITRILE (4-isopropylbenzonitrile); CUMINIC ALDEHYDE (4-isopropylbenzaldehyde); DAMASCENONE ((E)-1-(2,6,6-trimethylcyclohexa-1,3-dien-1-yl)but-2-en-1-one); DAMASCONE DELTA (1-(2,6,6-trimethyl-1-cyclohex-3-enyl)but-2-en-1-one); DECENAL-2-TRANS ((E)-dec-2-enal); DECENAL-4-TRANS ((E)-dec-4-enal); DECENAL-9 (9-decenal); DODECENAL ((E)-dodec-2-enal); DUPICAL ((E)-4-((3aS,7aS)-hexahydro-1H-4,7-methanoinden-5(6H)-ylidene)butanal); ESTERLY (ethyl cyclohexyl carboxylate); EVERNYL (methyl 2,4-dihydroxy-3,6-dimethylbenzoate); FLORIDILE ((E)-undec-9-enenitrile); FOLIONE (methyl oct-2-ynoate); GALBANONE (1-(5,5-dimethylcyclohex-1-en-1-yl)pent-4-en-1-one); ISOBUTYL QUINOLINE-2 (6-butan-2-yl-quinoline); ISOEUGENOL ((E)-2-methoxy-4-(prop-1-en-1-yl)phenol); ISOPROPYL QUINOLINE (6-isopropylquinoline); JAVANOL ((1-methyl-2-((1,2,2-trimethylbicyclo[3.1.0]hexan-3-yl)methyl)cyclopropyl)methanol); MACEAL (bicyclo[2.2.2]oct-5-ene-2-carboxaldehyde); METHYL OCTYNE CARBONATE (methyl non-2-ynoate); NEOCASPIRENE EXTRA (10-isopropyl-2,7-dimethyl-1-oxaspiro[4.5]deca-3,6-diene); NEOFOLIONE ((E)-methyl non-2-enoate); NEROLIONE (1-(3-methylbenzofuran-2-yl)ethanone); NONADIENAL ((2E,6Z)-nona-2,6-dienal); NONADIENOL-2,6 ((2Z,6E)-2,6-nonadien-1-ol); NONENAL-6-CIS ((Z)-non-6-enal); OXANE (2-methyl-4-propyl-1,3-oxathiane); PELARGENE (2-methyl-4-methylene-6-phenyltetrahydro-2H-pyran); PHARAONE (2-cyclohexylhepta-1,6-dien-3-one); POMAROSE ((2E,5E)-5,6,7-trimethylocta-2,5-dien-4-one); PYRALONE (6-(sec-butyl)quinoline); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SAFRALEINE (2,3,3-trimethyl-1-indanone); SAFRANAL (2,6,6-trimethylcyclohexa-1,3-dienecarbaldehyde); SCENTAURUS JUICY (4-(dodecylthio)-4-methylpentan-2-one); SPIROGALBANONE (1-(spiro[4.5]dec-6-en-7-yl)pent-4-en-1-one); SYRINGA ALDEHYDE (2-(p-tolyl)acetaldehyde); TOSCANOL (1-(cyclopropylmethyl)-4-methoxybenzene); TRANS 2 UNDECENAL ((E)-undec-2-enal); TRANS-2-HEXENAL ((E)-hex-2-enal); TRIDECENE-2-NITRILE ((E)-tridec-2-enenitrile) and UNDECATRIENE ((3E,5Z)-undeca-1,3,5-triene).

By “perfume composition” is meant here a mixture of perfume ingredients. By “perfume ingredient” is meant chemical substance (or group of chemical substances) having an odour that may be employed in perfumes for the primary purpose of providing a contribution of a pleasant odour, either alone or in combination with other perfume ingredients.

When encapsulated at the levels specified herein above, the mentioned combinations of perfume ingredients enhance the olfactive performance of a perfume composition to such an extent that the dosage of the same in a consumer product can be reduced to a particularly low level, while still providing the desired olfactive benefits.

In an encapsulated composition according to the present invention, each of the performance driving perfume ingredients is preferably present at a concentration equal to or less than the following maximum concentrations:
2,6,10-trimethylundec-9-enal: 1 wt.-%
2-methyldecanal: 1 wt.-%
undec-10-enal: 3 wt.-%
(E)-undec-9-enal: 5 wt.-%
3,8,8,11a-tetramethyldodecahydro-1H-3,5a-epoxynaphtho[2,1-c]oxepine: 10 wt.-% 1,3,4,5,6,7-hexahydro-β,1,1,5,5-pentamethyl-2H-2,4a-Methanonaphthalene-8-ethanol: 5 wt.-%
decahydro-2,2,6,6,7,8,8-heptamethyl indenofuran: 1 wt.-%
(4aR,5R,7aS,9R)-Octahydro-2,2,5,8,8,9a-hexamethyl-4H-4a,9-methanoazuleno[5,6-d]-1,3-dioxole: 0.25 wt.-%
7-isopentyl-2H-benzo[b][1,4]dioxepin-3(4H)-one: wt.-%
8-(sec-butyl)-5,6,7,8-tetrahydroquinoline: 1 wt.-%
2-(2-methylpropyl)quinoline: 1 wt.-%
5-isopropyl-2-methylphenol: 1 wt.-%
5-tert-butyl-2-methyl-5-propyl-2H-furan: 1 wt.-%
(E)-1-(2,6,6-trimethylcyclohex-2-en-1-yl)hepta-1,6-dien-3-one: 1 wt.-%
(4S)-4,7,7-trimethyl-6-thiabicyclo[3.2.1]octane: 0.5 wt.-%
1-methoxy-4-methylbenzene: 1.5 wt.-%
4-isopropylbenzonitrile: 0.5 wt.-%
4-isopropylbenzaldehyde: 1.5 wt.-%
(E)-1-(2,6,6-trimethylcyclohexa-1,3-dien-1-yl)but-2-en-1-one: 5 wt.-%
1-(2,6,6-trimethyl-1-cyclohex-3-enyl)but-2-en-1-one: 15 wt.-%
(E)-dec-2-enal: 1 wt.-%
(E)-dec-4-enal: 1 wt.-%
9-decenal: 0.5 wt.-%
(E)-dodec-2-enal: 0.5 wt.-%
(E)-4-((3aS,7aS)-hexahydro-1H-4,7-methanoinden-5(6H)-ylidene)butanal: 1 wt.-%
ethyl cyclohexyl carboxylate: 0.5 wt.-%
methyl 2,4-dihydroxy-3,6-dimethylbenzoate: 0.5 wt.-%
(E)-undec-9-enenitrile: 1 wt.-%
methyl oct-2-ynoate: 1 wt.-%
1-(5,5-dimethylcyclohex-1-en-1-yl)pent-4-en-1-one: 10 wt.-%
6-butan-2-yl-quinoline: 1 wt.-%
(E)-2-methoxy-4-(prop-1-en-1-yl)phenol: 1.5 wt.-%
6-isopropylquinoline: 1 wt.-%
(1-methyl-2-((1,2,2-trimethylbicyclo[3.1.0]hexan-3-yl)methyl)cyclopropyl)methanol: 10 wt.-%
bicyclo[2.2.2]oct-5-ene-2-carboxaldehyde: 0.5 wt.-%
methyl non-2-ynoate: 1 wt.-%
10-isopropyl-2,7-dimethyl-1-oxaspiro[4.5]deca-3,6-diene: 1.5 wt.-%
(E)-methyl non-2-enoate: 1 wt.-%
1-(3-methylbenzofuran-2-yl)ethanone: 10 wt.-%
(2E,6Z)-nona-2,6-dienal: 0.5 wt.-%
(2Z,6E)-2,6-nonadien-1-ol: 0.5 wt.-%
(Z)-non-6-enal: 0.5 wt.-%
2-methyl-4-propyl-1,3-oxathiane: wt.-%
2-methyl-4-methylene-6-phenyltetrahydro-2H-pyran: 5 wt.-%
2-cyclohexylhepta-1,6-dien-3-one: 0.5 wt.-%
(2E,5E)-5,6,7-trimethylocta-2,5-dien-4-one: 3 wt.-%
6-(sec-butyl)quinoline: 1.5 wt.-%
dec-9-en-1-ol: 2 wt.-%
4-methyl-2-(2-methylprop-1-en-1-yl)tetrahydro-2H-pyran: 2 wt.-%
4-methyl-2-phenyl-3,6-dihydro-2H-pyran: 15 wt.-%
2,3,3-trimethyl-1-indanone: 1 wt.-%
2,6,6-trimethylcyclohexa-1,3-dienecarbaldehyde: 0.5 wt.-%
1-(spiro[4.5]dec-6-en-7-yl)pent-4-en-1-one: 1.5 wt.-%
2-(p-tolyl)acetaldehyde: 20 wt.-%
1-(cyclopropylmethyl)-4-methoxybenzene: 1 wt.-%
(E)-undec-2-enal: 0.5 wt.-%
(E)-hex-2-enal: 0.5 wt.-%
(E)-tridec-2-enenitrile: 15 wt.-%
(3E,5Z)-undeca-1,3,5-triene: 15 wt.-%

It has been found that keeping the concentrations of the perfume ingredients below the provided maxima leads to improved results with regard to the olfactive perception, hedonic balance of the perfume composition and its suitability for encapsulation.

Furthermore, each of the performance driving perfume ingredients mentioned herein above can be present at a concentration equal to or higher than the minimum concentration of 0.001 wt.-%, preferably 0.01 wt.-%, more preferably 0.05 wt.-%.

In preferred embodiments of the present invention, the performance driving perfume ingredients are selected from the group consisting of ADOXAL (2,6,10-trimethylundec-9-enal); ALDEHYDE C 11 MOA (2-methyldecanal); ALDEHYDE C 11 UNDECYLENIC (undec-10-enal); ALDEHYDE ISO C 11 ((E)-undec-9-enal); AMBERKETAL (3,8,8,11a-tetramethyldodecahydro-1H-3,5a-epoxynaphtho[2,1-c]oxepine); CARVACROL (5-isopropyl-2-methylphenol); CETONE V ((E)-1-(2,6,6-trimethylcyclohex-2-en-1-yl)hepta-1,6-dien-3-one); CRESYL METHYL ETHER PARA (1-methoxy-4-methylbenzene); CUMIN NITRILE (4-isopropylbenzonitrile); CUMINIC ALDEHYDE (4-isopropylbenzaldehyde); DAMASCENONE ((E)-1-(2,6,6-trimethylcyclohexa-1,3-dien-1-yl)but-2-en-1-one); DECENAL-2-TRANS ((E)-dec-2-enal); DECENAL-4-TRANS ((E)-dec-4-enal); DECENAL-9 (9-decenal); DODECENAL ((E)-dodec-2-enal); ESTERLY (ethyl cyclohexyl carboxylate); EVERNYL (methyl 2,4-dihydroxy-3,6-dimethylbenzoate); FLORIDILE ((E)-undec-9-enenitrile); GALBANONE (1-(5,5-dimethylcyclohex-1-en-1-yl)pent-4-en-1-one); ISOEUGENOL ((E)-2-methoxy-4-(prop-1-en-1-yl)phenol); METHYL OCTYNE CARBONATE (methyl non-2-ynoate); NEOFOLIONE ((E)-methyl non-2-enoate); NEROLIONE (1-(3-methylbenzofuran-2-yl)ethanone); NONADIENAL ((2E,6Z)-nona-2,6-dienal); NONADIENOL-2,6 ((2Z,6E)-2,6-nonadien-1-ol); NONENAL-6-CIS ((Z)-non-6-enal); PHARAONE (2-cyclohexylhepta-1,6-dien-3-one); POMAROSE ((2E,5E)-5,6,7-trimethylocta-2,5-dien-4-one); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SAFRANAL (2,6,6-trimethylcyclohexa-1,3-dienecarbaldehyde); TOSCANOL (1-(cyclopropylmethyl)-4-methoxybenzene); TRANS 2 UNDECENAL ((E)-undec-2-enal); TRANS-2-HEXENAL ((E)-hex-2-enal); TRIDECENE-2-NITRILE ((E)-tridec-2-enenitrile); and UNDECATRIENE ((3E,5Z)-undeca-1,3,5-triene).

The above-mentioned performance driving perfume ingredients have the advantage of being biodegradable. In context of the present invention, a “biodegradable ingredient” is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results.

“Ultimate biodegradability” refers to the complete breakdown of a chemical into water, carbon dioxide and new biomass.

For assessment of the pass criteria for “readily biodegradable”, the biodegradation study can be selected from the group consisting of OECD Method 301C, OECD Method 301D, OECD Method 301F and OECD Method 310. These methods are suitable for volatile materials.

OECD Method 301C, OECD Method 301D and OECD Method 301F are described in the OECD Guidelines for the Testing of Chemicals, Section 3, Test No. 301: Ready Biodegradability (Adopted: 17th July 1992; https://doi.org/10.1787/97892640703-(9-en).

OECD Method 310 is described in the OECD Guidelines for the Testing of Chemicals, Section 3, Test No. 310: Ready Biodegradability—CO2 in sealed vessels (Headspace Test) (Adopted: 23 Mar. 2006; Corrected: 26 Sep. 2014; https://doi.org/10.1787/978926-(016316-en).

In a particular aspect of the present invention, the pass criteria for “readily biodegradable” are assessed according to OECD Method 301F, which refers to manometric respirometry. In this method the pass level for “ready biodegradability” is to reach 60% of theoretical oxygen demand and/or chemical oxygen demand. This pass value has to be reached in a 10-day window within the 28-day period of the test. The 10-day window begins when the degree of biodegradation has reached 10% of theoretical oxygen demand and/or chemical oxygen demand and must end before day 28 of the test.

Given a positive result in a test of ready biodegradability, it may be assumed that the ingredient will undergo rapid and ultimate biodegradation in the environment (Introduction to the OECD Guidelines for the Testing of Chemicals, Section 3, Part 1: Principles and Strategies Related to the Testing of Degradation of Organic Chemicals; Adopted: July 2003).

For assessment of the pass criteria for “inherently biodegradable”, the biodegradation study can be OECD Method 302C, but also OECD Method 301F can be used, although with different pass criteria. Also these methods are suitable for volatile materials.

OECD Method 302C is described in the OECD Guidelines for the Testing of Chemicals, Section 3, Test No. 302C: Inherent Biodegradability: Modified MITI Test (II) (Adopted: 12 May 1981; Corrected 8 Sep. 2009; https://doi.org/10.1787/9789264070400-en).

In a particular aspect of the present invention, the pass criteria for “inherently biodegradable” are assessed by OECD Method 302C. In this method the pass level for “inherently biodegradable” is then to reach 70% of theoretical oxygen demand. There is no time limit to reach this level.

Biodegradation rates above 70% may be regarded as evidence of inherent, ultimate biodegradability (OECD Guidelines for the Testing of Chemicals, Section 3, Part 1: Principles and Strategies Related to the Testing of Degradation of Organic Chemicals; Adopted: July 2003).

If OECD Method 301F is used for assessment of the pass criteria for “inherently biodegradable”, the pass level is 60% of theoretical oxygen demand and/or chemical oxygen demand. This pass value can be reached after the 28-day period of the test, which is usually extended to 60 days. No 10-day window applies.

In the present context, if an ingredient is an essential oil, it is considered to be a “biodegradable ingredient” if all of its constituents present at a level ≥1 wt.-% fall under the definition of “inherently biodegradable” and/or “readily biodegradable” as defined herein above. However, the essential oil can also be subjected to the above-mentioned biodegradation tests.

In a preferred embodiment of the present invention, the performance driving perfume ingredients are selected from ADOXAL (2,6,10-trimethylundec-9-enal); AZURONE (7-isopentyl-2H-benzo[b][1,4]dioxepin-3(4H)-one); CASSYRANE (5-tert-butyl-2-methyl-5-propyl-2H-furan); CETONE V ((E)-1-(2,6,6-trimethylcyclohex-2-en-1-yl)hepta-1,6-dien-3-one); CORPS PAMPLEMOUSSE ((4S)-4,7,7-trimethyl-6-thiabicyclo[3.2.1]octane); DAMASCENONE ((E)-1-(2,6,6-trimethylcyclohexa-1,3-dien-1-yl)but-2-en-1-one); DAMASCONE DELTA (1-(2,6,6-trimethyl-1-cyclohex-3-enyl)but-2-en-1-one); DECENAL-2-TRANS ((E)-dec-2-enal); ESTERLY (ethyl cyclohexyl carboxylate); FOLIONE (methyl oct-2-ynoate); GALBANONE (1-(5,5-dimethylcyclohex-1-en-1-yl)pent-4-en-1-one); MACEAL (bicyclo[2.2.2]oct-5-ene-2-carboxaldehyde); METHYL OCTYNE CARBONATE (methyl non-2-ynoate); NEOCASPIRENE EXTRA (10-isopropyl-2,7-dimethyl-1-oxaspiro[4.5]deca-3,6-diene); NEOFOLIONE ((E)-methyl non-2-enoate); NONADIENAL ((2E,6Z)-nona-2,6-dienal); NONADIENOL-2,6 ((2Z,6E)-2,6-nonadien-1-ol); NONENAL-6-CIS ((Z)-non-6-enal); OXANE (2-methyl-4-propyl-1,3-oxathiane); PELARGENE (2-methyl-4-methylene-6-phenyltetrahydro-2H-pyran); PHARAONE (2-cyclohexylhepta-1,6-dien-3-one); POMAROSE ((2E,5E)-5,6,7-trimethylocta-2,5-dien-4-one); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SPIROGALBANONE (1-(spiro[4.5]dec-6-en-7-yl)pent-4-en-1-one); TRANS-2-HEXENAL ((E)-hex-2-enal) and UNDECATRIENE ((3E,5Z)-undeca-1,3,5-triene). Those ingredients are particularly suitable for providing a perfume with a fruity character.

In a preferred embodiment of the present invention, the performance driving perfume ingredients are selected from ADOXAL (2,6,10-trimethylundec-9-enal); ALDEHYDE C 11 MOA (2-methyldecanal); ALDEHYDE C 11 UNDECYLENIC (undec-10-enal); ALDEHYDE ISO C 11 ((E)-undec-9-enal); AZURONE (7-isopentyl-2H-benzo[b][1,4]dioxepin-3(4H)-one); CETONE V ((E)-1-(2,6,6-trimethylcyclohex-2-en-1-yl)hepta-1,6-dien-3-one); CRESYL METHYL ETHER PARA (1-methoxy-4-methylbenzene); DAMASCENONE ((E)-1-(2,6,6-trimethylcyclohexa-1,3-dien-1-yl)but-2-en-1-one); DAMASCONE DELTA (1-(2,6,6-trimethyl-1-cyclohex-3-enyl)but-2-en-1-one); DECENAL-2-TRANS ((E)-dec-2-enal); DUPICAL ((E)-4-((3aS,7aS)-hexahydro-1H-4,7-methanoinden-5(6H)-ylidene)butanal); FOLIONE (methyl oct-2-ynoate); GALBANONE (1-(5,5-dimethylcyclohex-1-en-1-yl)pent-4-en-1-one); ISOEUGENOL ((E)-2-methoxy-4-(prop-1-en-1-yl)phenol); JAVANOL ((1-methyl-2-((1,2,2-trimethylbicyclo[3.1.0]hexan-3-yl)methyl)cyclopropyl)methanol); METHYL OCTYNE CARBONATE (methyl non-2-ynoate); NEOFOLIONE ((E)-methyl non-2-enoate); NEROLIONE (1-(3-methylbenzofuran-2-yl)ethanone); NONADIENAL ((2E,6Z)-nona-2,6-dienal); NONADIENOL-2,6 ((2Z,6E)-2,6-nonadien-1-ol); NONENAL-6-CIS ((Z)-non-6-enal); PELARGENE (2-methyl-4-methylene-6-phenyltetrahydro-2H-pyran); POMAROSE ((2E,5E)-5,6,7-trimethylocta-2,5-dien-4-one); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SPIROGALBANONE (1-(spiro[4.5]dec-6-en-7-yl)pent-4-en-1-one); SYRINGA ALDEHYDE (2-(p-tolyl)acetaldehyde) and UNDECATRIENE ((3E,5Z)-undeca-1,3,5-triene). Those ingredients are particularly suitable for providing a perfume with a floral character.

In a preferred embodiment of the present invention, the performance driving perfume ingredients are selected from ALDEHYDE C 11 MOA (2-methyldecanal); ALDEHYDE C 11 UNDECYLENIC (undec-10-enal); ALDEHYDE ISO C 11 ((E)-undec-9-enal); BIGARYL (8-(sec-butyl)-5,6,7,8-tetrahydroquinoline); CASSYRANE (5-tert-butyl-2-methyl-5-propyl-2H-furan); CORPS PAMPLEMOUSSE ((4S)-4,7,7-trimethyl-6-thiabicyclo[3.2.1]octane); DECENAL-4-TRANS ((E)-dec-4-enal); DECENAL-9 (9-decenal); DODECENAL ((E)-dodec-2-enal); FLORIDILE ((E)-undec-9-enenitrile); GALBANONE (1-(5,5-dimethylcyclohex-1-en-1-yl)pent-4-en-1-one); NEOCASPIRENE EXTRA (10-isopropyl-2,7-dimethyl-1-oxaspiro[4.5]deca-3,6-diene); NEROLIONE (1-(3-methylbenzofuran-2-yl)ethanone); OXANE (2-methyl-4-propyl-1,3-oxathiane); PELARGENE (2-methyl-4-methylene-6-phenyltetrahydro-2H-pyran); ROSE OXIDE CO (4-methyl-2-(2-methylprop-1-en-1-yl)tetrahydro-2H-pyran); TRANS 2 UNDECENAL ((E)-undec-2-enal) and TRIDECENE-2-NITRILE ((E)-tridec-2-enenitrile). Those ingredients are particularly suitable for providing a perfume with a citrus character.

In a preferred embodiment of the present invention, the performance driving perfume ingredients are selected from ADOXAL (2,6,10-trimethylundec-9-enal); ALDEHYDE C 11 MOA (2-methyldecanal); ALDEHYDE C 11 UNDECYLENIC (undec-10-enal); ALDEHYDE ISO C 11 ((E)-undec-9-enal); AMBER XTREM (decahydro-2,2,6,6,7,8,8-heptamethyl indenofuran); AMBERKETAL (3,8,8,11a-tetramethyldodecahydro-1H-3,5a-epoxynaphtho[2,1-c]oxepine); AMBERMAX (1,3,4,5,6,7-hexahydro-.beta.,1,1,5,5-pentamethyl-2H-2,4a-methano-naphthalene-8-ethanol); AMBROCENIDE ((4aR,5R,7aS,9R)-Octahydro-2,2,5,8,8,9a-hexamethyl-4H-4a,9-methanoazuleno[5,6-d]-1,3-dioxole); AZURONE (7-isopentyl-2H-benzo[b][1,4]dioxepin-3(4H)-one); BIGARYL (8-(sec-butyl)-5,6,7,8-tetrahydroquinoline); CARVACROL (5-isopropyl-2-methylphenol); CUMIN NITRILE (4-isopropylbenzonitrile); CUMINIC ALDEHYDE (4-isopropylbenzaldehyde); DECENAL-2-TRANS ((E)-dec-2-enal); DECENAL-4-TRANS ((E)-dec-4-enal); DECENAL-9 (9-decenal); EVERNYL (methyl 2,4-dihydroxy-3,6-dimethylbenzoate); FOLIONE (methyl oct-2-ynoate); GALBANONE (1-(5,5-dimethylcyclohex-1-en-1-yl)pent-4-en-1-one); MACEAL (bicyclo[2.2.2]oct-5-ene-2-carboxaldehyde); METHYL OCTYNE CARBONATE (methyl non-2-ynoate); NEOFOLIONE ((E)-methyl non-2-enoate); NONADIENAL ((2E,6Z)-nona-2,6-dienal); NONADIENOL-2,6 ((2Z,6E)-2,6-nonadien-1-ol); NONENAL-6-CIS ((Z)-non-6-enal); PHARAONE (2-cyclohexylhepta-1,6-dien-3-one); SPIROGALBANONE (1-(spiro[4.5]dec-6-en-7-yl)pent-4-en-1-one); TOSCANOL (1-(cyclopropylmethyl)-4-methoxybenzene); TRANS-2-HEXENAL ((E)-hex-2-enal) and UNDECATRIENE ((3E,5Z)-undeca-1,3,5-triene). Those ingredients are particularly suitable for providing a perfume with a green aromatic (fougere) character.

In a preferred embodiment of the present invention, the performance driving perfume ingredients are selected from ALDEHYDE C 11 MOA (2-methyldecanal); ALDEHYDE C 11 UNDECYLENIC (undec-10-enal); ALDEHYDE ISO C 11 ((E)-undec-9-enal); AMBER XTREM (decahydro-2,2,6,6,7,8,8-heptamethyl indenofuran); AMBERKETAL (3,8,8,11a-tetramethyldodecahydro-1H-3,5a-epoxynaphtho[2,1-c]oxepine); AMBERMAX (1,3,4,5,6,7-hexahydro-.beta.,1,1,5,5-pentamethyl-2H-2,4a-Methanonaphthalene-8-ethanol); AMBROCENIDE ((4aR,5R,7aS,9R)-Octahydro-2,2,5,8,8,9a-hexamethyl-4H-4a,9-methanoazuleno[5,6-d]-1,3-dioxole); BUTYL QUINOLINE SECONDARY (2-(2-methylpropyl)quinoline); CARVACROL (5-isopropyl-2-methylphenol); CETONE V ((E)-1-(2,6,6-trimethylcyclohex-2-en-1-yl)hepta-1,6-dien-3-one); CRESYL METHYL ETHER PARA (1-methoxy-4-methylbenzene); CUMIN NITRILE (4-isopropylbenzonitrile); CUMINIC ALDEHYDE (4-isopropylbenzaldehyde); DUPICAL ((E)-4-((3aS,7aS)-hexahydro-1H-4,7-methanoinden-5(6H)-ylidene)butanal); EVERNYL (methyl 2,4-dihydroxy-3,6-dimethylbenzoate); ISOBUTYL QUINOLINE-2 (6-butan-2-yl-quinoline); ISOPROPYL QUINOLINE (6-isopropylquinoline); JAVANOL ((1-methyl-2-((1,2,2-trimethylbicyclo[3.1.0]hexan-3-yl)methyl)cyclopropyl)methanol); PYRALONE (6-(sec-butyl)quinoline); SAFRALEINE (2,3,3-trimethyl-1-indanone) and SAFRANAL (2,6,6-trimethylcyclohexa-1,3-dienecarbaldehyde). Those ingredients are particularly suitable for providing a perfume with a woody/chypre character.

In a preferred embodiment of the present invention, the performance driving perfume ingredients are selected from AMBER XTREM (decahydro-2,2,6,6,7,8,8-heptamethyl indenofuran); AMBERKETAL (3,8,8,11a-tetramethyldodecahydro-1H-3,5a-epoxynaphtho[2,1-c]oxepine); AMBERMAX (1,3,4,5,6,7-hexahydro-.beta.,1,1,5,5-pentamethyl-2H-2,4a-Methanonaphthalene-8-ethanol); AMBROCENIDE ((4aR,5R,7aS,9R)-Octahydro-2,2,5,8,8,9a-hexamethyl-4H-4a,9-methanoazuleno[5,6-d]-1,3-dioxole); BUTYL QUINOLINE SECONDARY (2-(2-methylpropyl)quinoline); CETONE V ((E)-1-(2,6,6-trimethylcyclohex-2-en-1-yl)hepta-1,6-dien-3-one); CRESYL METHYL ETHER PARA (1-methoxy-4-methylbenzene); DAMASCENONE ((E)-1-(2,6,6-trimethylcyclohexa-1,3-dien-1-yl)but-2-en-1-one); DAMASCONE DELTA (1-(2,6,6-trimethyl-1-cyclohex-3-enyl)but-2-en-1-one); EVERNYL (methyl 2,4-dihydroxy-3,6-dimethylbenzoate); ISOBUTYL QUINOLINE-2 (6-butan-2-yl-quinoline); ISOEUGENOL ((E)-2-methoxy-4-(prop-1-en-1-yl)phenol); ISOPROPYL QUINOLINE (6-isopropylquinoline); JAVANOL ((1-methyl-2-((1,2,2-trimethylbicyclo[3.1.0]hexan-3-yl)methyl)cyclopropyl)methanol); POMAROSE ((2E,5E)-5,6,7-trimethylocta-2,5-dien-4-one); PYRALONE (6-(sec-butyl)quinoline); SAFRALEINE (2,3,3-trimethyl-1-indanone) and SAFRANAL (2,6,6-trimethylcyclohexa-1,3-dienecarbaldehyde). Those ingredients are particularly suitable for providing a perfume with an oriental character.

In preferred embodiments of the present invention, the core composition additionally comprises at least one further perfume ingredient. The further perfume ingredient is not selected from those mentioned in any of the groups provided herein above. A comprehensive list of perfume ingredients that may be used can be found in the perfumery literature, for example “Perfume & Flavor Chemicals” by S. Arctander (Allured Publishing, 1994). Encapsulated compositions according to the present invention preferably comprise perfume ingredients selected from the group consisting of ACETYL ISOEUGENOL ((E)-2-methoxy-4-(prop-1-en-1-yl)phenyl acetate); AGRUMEX (2-(tert-butyl)cyclohexyl acetate); ALDEHYDE C 10 DECYLIC (decanal); ALDEHYDE C 110 UNDECYLIC (undecanal); ALDEHYDE C 12 LAURIC (dodecanal); ALDEHYDE C 12 MNA PURE (2-methylundecanal); ALDEHYDE C 8 OCTYLIC (octanal); ALDEHYDE C 9 ISONONYLIC (3,5,5-trimethylhexanal); ALDEHYDE C 9 NONYLIC (nonanal); ALDEHYDE C 90 NONENYLIC ((E)-non-2-enal); ALDEHYDE MANDARINE ((E)-dodec-2-enal); ALLYL AMYL GLYCOLATE (prop-2-enyl 2-(3-methylbutoxy)acetate); ALLYL CAPROATE (prop-2-enyl hexanoate); ALLYL CYCLOHEXYL PROPIONATE (prop-2-enyl 3-cyclohexylpropanoate); ALLYL OENANTHATE (prop-2-enyl heptanoate); AMBER CORE1-((2-(tert-butyl)cyclohexyl)oxy)butan-2-ol); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL BUTYRATE (pentyl butanoate); AMYL CINNAMIC ALDEHYDE ((Z)-2-benzylideneheptanal); AMYL SALICYLATE (pentyl 2-hydroxybenzoate); ANETHOLE SYNTHETIC ((E)-1-methoxy-4-(prop-1-en-1-yl)benzene); ANISYL ACETATE (4-methoxybenzyl acetate); APHERMATE (1-(3,3-dimethylcyclohexyl)ethyl formate); AUBEPINE PARA CRESOL (4-methoxybenzaldehyde); AURANTIOL ((E)-methyl 2-((7-hydroxy-3,7-dimethyloctylidene)amino)benzoate); BELAMBRE ((1R,2S,4R)-2′-isopropyl-1,7,7-trimethylspiro[bicyclo[2.2.1]heptane-2,4′-[1,3]dioxane]); BENZALDEHYDE (benzaldehyde); BENZYL ACETATE (benzyl acetate); BENZYL ACETONE (4-phenylbutan-2-one); BENZYL BENZOATE (benzyl benzoate); BENZYL SALICYLATE (benzyl 2-hydroxybenzoate); BERRYFLOR (ethyl 6-acetoxyhexanoate); BICYCLO NONALACTONE (octahydro-2H-chromen-2-one); BOISAMBRENE FORTE ((ethoxymethoxy)cyclododecane); BOISIRIS ((1S,2R,5R)-2-ethoxy-2,6,6-trimethyl-9-methylenebicyclo[3.3.1]nonane); BORNEOL CRYSTALS ((1S,2S,4S)-1,7,7-trimethylbicyclo[2.2.1]heptan-2-ol); BORNYL ACETATE ((2S,4S)-1,7,7-trimethylbicyclo[2.2.1]heptan-2-yl acetate); BOURGEONAL (3-(4-(tert-butyl)phenyl)propanal); BUTYL BUTYRO LACTATE (1-butoxy-1-oxopropan-2-yl butanoate); BUTYL CYCLOHEXYL ACETATE PARA (4-(tert-butyl)cyclohexyl acetate); CAMPHOR SYNTHETIC ((1S,4S)-1,7,7-trimethylbicyclo[2.2.1]heptan-2-one); CARVONE LAEVO ((5R)-2-methyl-5-prop-1-en-2-ylcyclohex-2-en-1-one); CASHMERAN (1,1,2,3,3-pentamethyl-2,3,6,7-tetrahydro-1H-inden-4(5H)-one); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CINNAMIC ALCOHOL SYNTHETIC ((E)-3-phenylprop-2-en-1-ol); CINNAMIC ALDEHYDE ((2E)-3-phenylprop-2-enal); CINNAMYL ACETATE ((E)-3-phenylprop-2-en-1-yl acetate); CIS JASMONE ((Z)-3-methyl-2-(pent-2-en-1-yl)cyclopent-2-enone); CIS-3-HEXENOL ((Z)-hex-3-en-1-ol); CITRAL TECH ((E)-3,7-dimethylocta-2,6-dienal); CITRATHAL R ((Z)-1,1-diethoxy-3,7-dimethylocta-2,6-diene); CITRONELLAL (3,7-dimethyloct-6-enal); CITRONELLOL EXTRA (3,7-dimethyloct-6-en-1-ol); CITRONELLYL ACETATE (3,7-dimethyloct-6-en-1-yl acetate); CITRONELLYL FORMATE (3,7-dimethyloct-6-en-1-yl formate); CITRONELLYL NITRILE (3,7-dimethyloct-6-enenitrile); CLONAL (dodecanenitrile); CORANOL (4-cyclohexyl-2-methylbutan-2-ol); COSMONE ((Z)-3-methylcyclotetradec-5-enone); COUMARIN PURE CRYSTALS (2H-chromen-2-one); CRESYL ACETATE PARA ((4-methylphenyl) acetate); CYCLAMEN ALDEHYDE EXTRA (3-(4-isopropylphenyl)-2-methylpropanal); CYCLOGALBANATE (allyl 2-(cyclohexyloxy)acetate); CYCLOHEXYL ETHYL ACETATE (2-cyclohexylethyl acetate); CYCLOHEXYL SALICYLATE (cyclohexyl 2-hydroxybenzoate); CYCLOMYRAL (8,8-dimethyl-1,2,3,4,5,6,7,8-octahydronaphthalene-2-carbaldehyde); CYMENE PARA (1-methyl-4-propan-2-ylbenzene); DAMASCONE ALPHA ((E)-1-(2,6,6-trimethylcyclohex-2-en-1-yl)but-2-en-1-one); DECALACTONE GAMMA (5-hexyloxolan-2-one); DELPHONE (2-pentylcyclopentanone); DELTA-3 CARENE ((1S,6S)-3,7,7-trimethylbicyclo[4.1.0]hept-3-ene); DIHEXYL FUMARATE (dihexyl-but-2-enedioate); DIHYDRO ANETHOLE (1-methoxy-4-propylbenzene); DIHYDRO JASMONE (3-methyl-2-pentylcyclopent-2-enone); DIHYDRO MYRCENOL (2,6-dimethyloct-7-en-2-ol); DIMETHYL ANTHRANILATE (methyl 2-(methylamino)benzoate); DIMETHYL BENZYL CARBINOL (2-methyl-1-phenylpropan-2-ol); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETHYL OCTENONE (4,7-dimethyloct-6-en-3-one); DIMETOL (2,6-dimethylheptan-2-ol); DIPENTENE (1-methyl-4-(prop-1-en-2-yl)cyclohex-1-ene); DIPHENYL OXIDE (oxydibenzene); DODECALACTONE DELTA (6-heptyltetrahydro-2H-pyran-2-one); DODECALACTONE GAMMA (5-octyloxolan-2-one); EBANOL ((E)-3-methyl-5-(2,2,3-trimethylcyclopent-3-en-1-yl)pent-4-en-2-ol); ETHYL ACETATE (ethyl acetate); ETHYL ACETOACETATE (ethyl 3-oxobutanoate); ETHYL CINNAMATE (ethyl 3-phenylprop-2-enoate); ETHYL HEXANOATE (ethyl hexanoate); ETHYL LINALOOL ((E)-3,7-dimethylnona-1,6-dien-3-ol); ETHYL LINALYL ACETATE ((Z)-3,7-dimethylnona-1,6-dien-3-yl acetate); ETHYL MALTOL (2-ethyl-3-hydroxy-4H-pyran-4-one); ETHYL METHYL-2-BUTYRATE (ethyl 2-methylbutanoate); ETHYL OCTANOATE (ethyl octanoate); ETHYL OENANTHATE (ethyl heptanoate); ETHYL PHENYL GLYCIDATE (ethyl 3-phenyloxirane-2-carboxylate); ETHYL SAFRANATE (ethyl 2,6,6-trimethylcyclohexa-1,3-diene-1-carboxylate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); FENCHYL ACETATE ((2S)-1,3,3-trimethylbicyclo[2.2.1]heptan-2-yl acetate); FENCHYL ALCOHOL ((1S,2R,4R)-1,3,3-trimethylbicyclo[2.2.1]heptan-2-ol); FENNALDEHYDE (3-(4-methoxyphenyl)-2-methylpropanal); FIXAMBRENE (3a,6,6,9a-tetramethyldodecahydronaphtho[2,1-b]furan); FIXOLIDE (1-(3,5,5,6,8,8-hexamethyl-5,6,7,8-tetrahydronaphthalen-2-yl)ethanone); FLORALOZONE (3-(4-ethylphenyl)-2,2-dimethylpropanalFLORHYDRAL3-(3-isopropylphenyl)butanal; FLOROCYCLENE (3aR,6S,7aS)-3a,4,5,6,7,7a-hexahydro-1H-4,7-methanoinden-6-yl propanoate); FLOROPAL (2,4,6-trimethyl-4-phenyl-1,3-dioxane); FLOROSA HC (tetrahydro-4-methyl-2-(2-methylpropyl)-2H-pyran-4-ol); FRESKOMENTHE (2-(sec-butyl)cyclohexanone); FRUCTONE (ethyl 2-(2-methyl-1,3-dioxolan-2-yl)acetate); FRUITATE ((3aS,4S,7R,7aS)-ethyl octahydro-1H-4,7-methanoindene-3a-carboxylate); FRUTONILE (2-methyldecanenitrile); GARDENOL (1-phenylethyl acetate); GARDOCYCLENE ((3aR,6S,7aS)-3a,4,5,6,7,7a-hexahydro-1H-4,7-methanoinden-6-yl 2-methyl propanoate); GERANIOL ((E)-3,7-dimethylocta-2,6-dien-1-ol); GERANYL ACETATE ((E)-3,7-dimethylocta-2,6-dien-1-yl acetate); GERANYL CROTONATE ((E)-3,7-dimethylocta-2,6-dien-1-yl but-2-enoate); GERANYL ISOBUTYRATE ((E)-3,7-dimethylocta-2,6-dien-1-yl 2-methylpropanoate); GIVESCONE (ethyl 2-ethyl-6,6-dimethylcyclohex-2-enecarboxylate); HABANOLIDE ((E)-oxacyclohexadec-12-en-2-one); HEDIONE (methyl 3-oxo-2-pentylcyclopentaneacetate); HELIOTROPINE CRYSTALS (benzo[d][1,3]dioxole-5-carbaldehyde); HERBANATE ((2S)-ethyl 3-isopropylbicyclo[2.2.1]hept-5-ene-2-carboxylate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS BUTYRATE ((Z)-hex-3-en-1-yl butanoate); HEXENYL-3-CIS ISOBUTYRATE ((Z)-hex-3-en-1-yl 2-methylpropanoate); HEXENYL-3-CIS SALICYLATE ((Z)-hex-3-en-1-yl 2-hydroxybenzoate); HEXYL ACETATE (hexyl acetate); HEXYL BENZOATE (hexyl benzoate); HEXYL BUTYRATE (hexyl butanoate); HEXYL CINNAMIC ALDEHYDE ((E)-2-benzylideneoctanal); HEXYL ISOBUTYRATE (hexyl 2-methylpropanoate); HEXYL SALICYLATE (hexyl 2-hydroxybenzoate); HYDROXYCITRONELLAL (7-hydroxy-3,7-dimethyloctanal); INDOFLOR (4,4a,5,9b-tetrahydroindeno[1,2-d][1,3]dioxine); INDOLE PURE (1H-indole); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); IRONE ALPHA ((E)-4-(2,5,6,6-tetramethylcyclohex-2-en-1-yl)but-3-en-2-one); ISO E SUPER (1-(2,3,8,8-tetramethyl-1,2,3,4,5,6,7,8-octahydronaphthalen-2-yl)ethanone); ISOAMYL ACETATE (3-methylbutyl acetate); ISOAMYL BUTYRATE (3-methylbutyl butanoate); ISOBUTYL METHOXY PYRAZINE (2-methylpropyl 3-methoxypyrazine); ISOCYCLOCITRAL (2,4,6-trimethylcyclohex-3-enecarbaldehyde); ISOEUGENOL ((E)-2-methoxy-4-(prop-1-en-1-yl)phenol); ISOJASMONE B 11 (2-hexylcyclopent-2-en-1-one); ISOMENTHONE DL (2-isopropyl-5-methylcyclohexanone); ISONONYL ACETATE (3,5,5-trimethylhexyl acetate); ISOPROPYL METHYL-2-BUTYRATE (isopropyl 2-methylbutanoate); ISOPROPYL QUINOLINE (6-isopropylquinoline); ISORALDEINE ((E)-3-methyl-4-(2,6,6-trimethylcyclohex-2-en-1-yl)but-3-en-2-one); JASMACYCLENE ((3aR,6S,7aS)-3a,4,5,6,7,7a-hexahydro-1H-4,7-methanoinden-6-yl acetate); JASMONE CIS ((Z)-3-methyl-2-(pent-2-en-1-yl)cyclopent-2-enone); JASMONYL (3-butyl-5-methyltetrahydro-2H-pyran-4-yl acetate); JASMOPYRANE FORTE (3-pentyltetrahydro-2H-pyran-4-yl acetate); KOAVONE ((Z)-3,4,5,6,6-pentamethylhept-3-en-2-one); LAITONE (8-isopropyl-1-oxaspiro[4.5]decan-2-one); LEAF ACETAL ((Z)-1-(1-ethoxyethoxy)hex-3-ene); LEMONILE ((2E,6Z)-3,7-dimethylnona-2,6-dienenitrile); LIFFAROME ((Z)-hex-3-en-1-yl methyl carbonate); LILIAL (3-(4-(tert-butyl)phenyl)-2-methylpropanal); LINALOOL (3,7-dimethylocta-1,6-dien-3-ol); LINALOOL OXIDE (2-(5-methyl-5-vinyltetrahydrofuran-2-yl)propan-2-ol); LINALYL ACETATE (3,7-dimethylocta-1,6-dien-3-yl acetate); MAHONIAL ((4E)-9-hydroxy-5,9-dimethyl-4-decenal); MALTOL (3-hydroxy-2-methyl-4H-pyran-4-one); MALTYL ISOBUTYRATE (2-methyl-4-oxo-4H-pyran-3-yl 2-methylpropanoate); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MERCAPTO-8-METHANE-3-ONE (mercapto-para-menthan-3-one); METHYL ANTHRANILATE (methyl 2-aminobenzoate); METHYL BENZOATE (methyl benzoate); METHYL CEDRYL KETONE (1-((1S,8aS)-1,4,4,6-tetramethyl-2,3,3a,4,5,8-hexahydro-1H-5,8a-methanoazulen-7-yl)ethanone); METHYL CINNAMATE (methyl 3-phenylprop-2-enoate); METHYL DIANTILIS (2-ethoxy-4-(methoxymethyl)phenol); METHYL DIHYDRO ISOJASMONATE (methyl 2-hexyl-3-oxocyclopentane-1-carboxylate); METHYL HEPTENONE PURE (6-methylhept-5-en-2-one); METHYL LAITONE (8-methyl-1-oxaspiro[4.5]decan-2-one); METHYL NONYL KETONE (undecan-2-one); METHYL PAMPLEMOUSSE (6,6-dimethoxy-2,5,5-trimethylhex-2-ene); METHYL SALICYLATE (methyl 2-hydroxybenzoate); MUSCENONE ((Z)-3-methylcyclopentadec-5-enone); MYRALDENE (4-(4-methylpent-3-en-1-yl)cyclohex-3-enecarbaldehyde); MYRCENE (7-methyl-3-methyleneocta-1,6-diene); MYSTIKAL (2-methylundecanoic acid); NECTARYL (2-(2-(4-methylcyclohex-3-en-1-yl)propyl)cyclopentanone); NEOBERGAMATE FORTE (2-methyl-6-methyleneoct-7-en-2-yl acetate); NEROLEX ((2Z)-3,7-dimethylocta-2,6-dien-1-ol); NEROLIDOL ((Z)-3,7,11-trimethyldodeca-1,6,10-trien-3-ol); NEROLIDYLE ((Z)-3,7,11-trimethyldodeca-1,6,10-trien-3-yl acetate); NEROLINE CRYSTALS (2-ethoxynaphthalene); NERYL ACETATE ((Z)-3,7-dimethylocta-2,6-dien-1-yl acetate); NIRVANOLIDE ((E)-13-methyloxacyclopentadec-10-en-2-one); NONADYL (6,8-dimethylnonan-2-ol); NONALACTONE GAMMA (5-pentyloxolan-2-one); NONENOL-6-CIS ((Z)-non-6-en-1-ol); NOPYL ACETATE (2-(6,6-dimethylbicyclo[3.1.1]hept-2-en-2-yl)ethyl acetate); NYMPHEAL (3-(4-(2-methylpropyl)-2-methylphenyl)propanal); OCTALACTONE DELTA (6-propyltetrahydro-2H-pyran-2-one); METHYL HEXYL KETONE (octan-2-one); ORANGER CRYSTALS (1-(2-naphtalenyl)-ethanone); ORIVONE (4-(tert-pentyl)cyclohexanone); PANDANOL ((2-methoxyethyl)benzene); PARA TERT BUTYL CYCLOHEXYL ACETATE (4-(tert-butyl)cyclohexyl acetate); PARADISAMIDE (2-ethyl-N-methyl-N-(m-tolyl)butanamide); PEACH PURE (5-heptyldihydrofuran-2(3H)-one); PELARGOL (3,7-dimethyloctan-1-ol); PEONILE (2-cyclohexylidene-2-phenylacetonitrile); PETALIA (2-cyclohexylidene-2-(o-tolyl)acetonitrile); PHARAONE (2-cyclohexylhepta-1,6-dien-3-one); PHENOXY ETHYL ISOBUTYRATE (2-(phenoxy)ethyl 2-methylpropanoate); PHENYL ACETALDEHYDE (2-phenyl-ethanal); PHENYL ETHYL ACETATE (2-phenylethyl acetate); PHENYL ETHYL ALCOHOL (2-phenylethanol); PHENYL ETHYL ISOBUTYRATE (2-phenylethyl 2-methylpropanoate); PHENYL ETHYL PHENYL ACETATE (2-phenylethyl 2-phenylacetate); PHENYL PROPYL ALCOHOL (3-phenylpropan-1-ol); PINENE ALPHA (2,6,6-trimethylbicyclo[3.1.1]hept-2-ene); PINENE BETA (6,6-dimethyl-2-methylenebicyclo[3.1.1]heptane); PINOACETALDEHYDE (3-(6,6-dimethylbicyclo[3.1.1]hept-2-en-2-yl)propanal); PIVAROSE (2,2-dimethyl-2-pheylethyl propanoate); POMELOL (2,4,7-Trimethyl-6-octen-1-ol); PRECYCLEMONE B (1-methyl-4-(4-methylpent-3-en-1-yl)cyclohex-3-enecarbaldehyde); PRENYL ACETATE (3-methylbut-2-en-1-yl acetate); PRUNOLIDE (5-pentyldihydrofuran-2(3H)-one); RADJANOL SUPER ((E)-2-ethyl-4-(2,2,3-trimethylcyclopent-3-en-1-yl)but-2-en-1-ol); RASPBERRY KETONE (4-(4-hydroxyphenyl)butan-2-one); RHUBAFURAN (2,4-dimethyl-4-phenyltetrahydrofuran); ROSACETOL (2,2,2-trichloro-1-phenylethyl acetate); ROSE OXIDE (4-methyl-2-(2-methylprop-1-en-1-yl)tetrahydro-2H-pyran); ROSE OXIDE CO (4-methyl-2-(2-methylprop-1-en-1-yl)tetrahydro-2H-pyran); ROSYFOLIA (1-methyl-2-(5-methylhex-4-en-2-yl)cyclopropylmethanol); SANDALORE EXTRA (3-methyl-5-(2,2,3-trimethylcyclopent-3-en-1-yl)pentan-2-ol); SCENTAURUS CLEAN (ethyl (Z)-2-acetyl-4-methyltridec-2-enoate); SERENOLIDE (2-(1-(3,3-dimethylcyclohexyl)ethoxy)-2-methylpropyl cyclopropanecarboxylate); SILVANONE SUPRA (cyclopentadecanone, hexadecanolide); SILVIAL (2-methyl-3-[4-(2-methylpropyl)phenyl]propanal); STEMONE ((E)-5-methylheptan-3-one oxime); STYRALLYL ACETATE (1-phenylethyl acetate); SUPER MUGUET ((E)-6-ethyl-3-methyloct-6-en-1-ol); SYLKOLIDE ((E)-2-((3,5-dimethylhex-3-en-2-yl)oxy)-2-methylpropyl cyclopropanecarboxylate); TERPINENE ALPHA (1-methyl-4-propan-2-ylcyclohexa-1,3-diene); TERPINENE GAMMA (1-methyl-4-propan-2-ylcyclohexa-1,4-diene); TERPINEOL (2-(4-methylcyclohex-3-en-1-yl)propan-2-ol); TERPINEOL ALPHA (2-(4-methyl-1-cyclohex-3-enyl)propan-2-ol); TERPINEOL PURE (2-(4-methylcyclohex-3-en-1-yl)propan-2-ol); TERPINOLENE (1-methyl-4-(propan-2-ylidene)cyclohex-1-ene); TERPINYL ACETATE (2-(4-methyl-1-cyclohex-3-enyl)propan-2-yl acetate); TETRAHYDRO LINALOOL (3,7-dimethyloctan-3-ol); TETRAHYDRO MYRCENOL (2,6-dimethyloctan-2-ol); THIBETOLIDE (oxacyclohexadecan-2-one); THYMOL (2-isopropyl-5-methylphenol); TRICYCLAL (2,4-dimethylcyclohex-3-enecarbaldehyde); TRIFERNAL (3-phenylbutanal); TROPIONAL (3-(benzo[d][1,3]dioxol-5-yl)-2-methylpropanal); TROPIONAL (3-(benzo[d][1,3]dioxol-5-yl)-2-methylpropanal); UNDECAVERTOL ((E)-4-methyldec-3-en-5-ol); VANILLIN (4-hydroxy-3-methoxybenzaldehyde); VELOUTONE (2,2,5-trimethyl-5-pentylcyclopentanone); VELVIONE ((Z)-cyclohexadec-5-enone); VIOLET NITRILE ((2E,6Z)-nona-2,6-dienenitrile); YARA YARA (2-methoxynaphtalene); ZINARINE (2-(2,4-dimethylcyclohexyl)pyridine; BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil) and YLANG ECO ESSENCE (ylang oil). These fragrance ingredients are particularly suitable for obtaining stable and performing microcapsules, owing to their favorable lipophilicity and olfactive performance.

In preferred embodiments of the present invention, the at least one further perfume ingredients is biodegradable.

The shell of the microcapsules comprises encapsulating materials which are preferably impervious to the core material when the microcapsules are stored, in particular in a consumer product base. Such impervious shell materials are well known in the prior art.

In preferred embodiments of the present invention, the shell comprises a melamine-formaldehyde polymer. This type of core-shell capsule has proved to be particularly suitable for fragrance encapsulation and is described in the prior art, for instance in WO 2008/098387 A1, WO 2016/207180 A1 and WO 2017/001672 A1.

Alternatively, the shell can also comprise a polyurea or polyurethane polymer. Also this type of core-shell capsule has been successfully used for perfume encapsulation and has the advantage to address consumer concerns with regard to residual formaldehyde in the composition. Such capsules are also described in the prior art, for instance in WO 2019/174978 A1.

As a further alternative, the shell can comprise, in polymerized form, one or more monoethylenically unsaturated and/or polyethylenically unsaturated monomer(s). Also this type of core-shell capsule has been successfully used for perfume encapsulation. Such capsules are described in the prior art, for instance in WO 2013/111912 A1 or WO 2014/032920 A1.

Such microcapsules may be obtained by methods known to the prior art. The size of the microcapsules obtained by such methods may be optimized to the desired value by varying the stirring speed and/or stirrer geometry during the synthesis of the microcapsules, in particular during the emulsification step preceding the formation of the microcapsule shell.

In preferred embodiments of the present invention, the volume median diameter Dv(50) of the microcapsules is from 1 to 50 μm, more preferably from 5 to 35 μm, still more preferably from 8 to 20 μm. Microcapsules having a volume median diameter larger than 50 μm are not desired, because of the fact that individual microcapsules of that size may be visible for the human eye, while microcapsules below 1 μm may have a too large of a surface to volume ratio in order to retain the functional material comprised in the core or the microcapsules over time, especially if this functional material is soluble in the consumer product or is volatile.

The encapsulated composition can be in form of a slurry wherein the core-shell microcapsules are dispersed or suspended in an aqueous phase. The slurry can have a solid content of from 20 wt.-% to 60 wt.-%, preferably from 35 wt.-% to 45 wt.-%. The percentage of microcapsules in a slurry is referred to as “solid content” and is measured experimentally by methods known in the prior art. The solid content of a slurry includes both core and shell materials. For example, the solid content may be measured by using a thermo-balance operating at, for example, 120° C. The solid content, expressed as weight percentage of the initial slurry deposited on the balance may be taken at the point where the drying-induced rate of weight change has dropped below 0.1%/min. If the solid content is too low, then the process may not be sufficiently economic at industrial scales, whereas stable slurries with higher solid content may not be stable enough with respect to phase separation and are difficult to obtain in practice.

In preferred embodiments of the present invention, the slurry comprises from 1 wt.-% to 10 wt.-%, preferably from 2 wt.-% to 6 wt.-% of, shell material.

Furthermore, the level of shell material in a core-shell microcapsule is preferably from 2 wt.-% to 20 wt.-%, more preferably from 4 wt.-% to 16 wt.-%, even more preferably from 5 wt.-% to 12 wt.-%, based on the total weight of the core-shell microcapsule.

In the present context, the amount of shell material in the core-shell microcapsules or in a slurry of core-shell microcapsules, but also in a consumer product (see below), is defined as the total amount of materials comprising shell-forming monomeric units. Practically, this amount can be determined by calculating the total amount of starting materials comprising shell-forming monomeric units that are added into the reactor in which the microencapsulation process is conducted.

The amount of shell material is an important parameter for the imperviousness of the microcapsule shell. If this amount is too low, the shell may not be sufficiently impervious to prevent leakage of the encapsulated functional material, in particular in a consumer product base. On the other hand, if the amount of shell material is too high, then the shell may be too impervious or not be sufficiently brittle, preventing thereby the controlled release of the encapsulated material.

The microcapsules can be stabilized against agglomeration, creaming or sedimentation by employing a suspending agent. The suspending agent may be added under stirring before the microcapsules are formed, during formation of the microcapsules or after the microcapsules have been formed (post-addition). Preferably, the suspending agent is post-added to the slurry of microcapsules under stirring.

Suspending agents may be selected from a broad class of water-soluble or water-dispersible polymers having anionic, cationic, zwitterionic or non-ionic character. Water-soluble or water-dispersible polymers useful for the sake of the present invention encompass:

Polysaccharides, such as starch, modified starch, dextrin, maltodextrin, and cellulose derivatives, and their quaternized forms; natural gums such as alginate esters, carrageenan, xanthan, agar-agar, pectins, pectic acid, and natural gums such as gum arabic, gum tragacanth and gum karaya, guar gums and quaternized guar gums; gelatine, protein hydrolysates and their quaternized forms; synthetic polymers and copolymers, such as poly(vinyl pyrrolidone-co-vinyl acetate), poly(vinyl alcohol-co-vinyl acetate), poly((met)acrylic acid), poly(maleic acid), poly(alkyl(meth)acrylate-co-(meth)acrylic acid), poly(acrylic acid-co-maleic acid)copolymer, poly(alkyleneoxide), poly(vinyl-co-methylether), poly(vinylether-co-maleic anhydride), and the like, as well as poly(ethyleneimine), poly((meth)acrylamide), poly(alkyleneoxide-co-dimethylsiloxane), poly(amino dimethylsiloxane), and their quaternized forms.

The present invention also relates to a consumer product comprising an encapsulated composition as described herein above, preferably a fabric care product, a home care product or a personal care product.

The encapsulated compositions of the present invention may be used to perfume all manners of consumer products, including laundry care detergents, laundry care conditioners, fabric refreshers, personal care cleansing compositions, such as shampoos, bath and shower gels, liquid soaps, soap bars, personal care conditioning composition, such as hair care conditioners, bath and shower lotions, deodorant compositions, antiperspirant compositions, home care compositions, such as hard surface cleaners, and heavy duty detergents, and fragranced products comprising ethanol.

Encapsulated compositions according to the present invention are particularly useful when employed as perfume delivery vehicles in consumer goods that require, for delivering optimal perfumery benefits, the microcapsules to adhere well to a substrate on which they are applied.

Liquid detergent compositions that are concerned by the invention may be regular or concentrated detergents. They may be available as single dose “pouches” or “liquid tabs”.

Laundry care liquid detergents comprise anionic and/or non-ionic surfactants, and mixtures thereof. Typical anionic surfactants include sodium lauryl sulphate, sodium laureth sulphate, sodium trideceth sulphate, ammonium lauryl sulphate, ammonium laureth sulphate, potassium laureth sulphate, linear alkyl benzene sulfonates, sodium tridecyl benzene sulfonate, sodium dodecyl benzene sulfonate, sodium xylene sulfonate, monoethanolamine lauryl sulphate, monoethanolamine laureth sulphate, triethanolamine lauryl sulphate, triethanolamine laureth sulphate, lauryl sarcosine, cocoyl sarcosine, sodium lauryl sarcosinate, sodium lauroyl sarcosinate, triethylamine lauryl sulphate, triethylamine laureth sulphate, diethanolamine lauryl sulphate, diethanolamine laureth sulphate, lauric monoglyceride sodium sulphate, ammonium cocoyl sulphate, ammonium lauroyl sulphate, sodium cocoyl sulphate, sodium lauroyl sulphate, sodium cocoyl isethionate, potassium cocoyl sulphate, potassium lauryl sulphate, monoethanolamine cocoyl sulphate, monoethanolamine lauryl sulphate, triethanolamine lauryl sulphate, C5-C17 acyl-N-(C1-C4 alkyl) glucamine sulphate, C5-C17 acyl-N-(C1-C4 hydroxyalkyl) glucamine sulphate, sodium hydroxyethyl-2-decyl ether sulphates, sodium methyl-2-hydroxydecyl ether sulphates, sodium hydroxyethyl-2-dodecyl ether sulphates, sodium monoethoxylated lauryl alkyl sulphates, C12-C18 alkyl sulfonates, ethoxylated or native linear and ramified C12-C18 alcohol sulphates, ethoxylated or native linear and ramified C12-C18 alcohol sulphates, and mixtures thereof. The above-mentioned anionic surfactants may also be used in their unneutralized, acid form.

Typically, the level of anionic surfactants in liquid detergents is from 1 to 40% by weight, more particularly from 5 to 35% by weight of the liquid detergent.

Typical non-ionic surfactants include C6-C24 alkyl ethoxylates with 1 to 12 ethylene oxide units. The alkyl chain of the aliphatic alcohol can either be straight or branched, primary or secondary, and generally contains from 6 to 22 carbon atoms. Further examples of non-ionic surfactants include the condensation products of fatty acids with glucamines, such as C12-C16 akyl N-methyl glucamide, and/or the condensation product of fatty acids with eth-oxylated amines; C10-C20 alkyl mono- or di-alkanolamides, where the alkyloxy group has 1 to 3 carbon atoms, C.10-C20 alkyl mono- or di-alknolamide having an intermediate polyoxyalkylene moiety having 2 to 20 alkyleneoxide groups between the alkyl moiety and the alkanolamide moiety; alkyl amidopropyl dimethylamine; fatty acid alkyl esters, such as sorbitol esters with oleic, myristic, stearic, palmitic acid, and the like, also known under the trade name Tween, such as Tween 20, Tween 40, and Tween 60; alkyl polyglycosides including, for example, C8-C10 alkyl polyglycosides, C12-C16 alkyl polyglycosides, C5 amyl polyglycosides. Further non-ionic surfactants include glycerol-based surfactants, such as fatty acid polyglyceryl esters like octanoic acid hexaglyceryl ester, decanoic acid tetraglyceryl ester, riccinoleic acid hexaglyceryl ester and cocoic acids tetraglyceryl esters and their mixtures. The term “alkyl” as used hereinabove for the non-ionic sugar-based surfactant refers to saturated linear alkyl residues having 3 to 21 carbon atoms, including hexyl, octyl, decanyl, dodecanyl, tetradecanyl, hexadecanyl, and octadecanyl. Typically, the level of non-ionic surfactants in liquid detergents is from 0 to 40% by weight, more particularly from 10 to 35% by weight of the detergent.

In some cases, the liquid detergent may also comprise cationic, cationogenic, zwitterionic and/or amphoteric surfactants.

Unit dose, pouched formats are well known in the art. Pouched formats typically comprise a liquid detergent base surrounded by a water-soluble film. Owing to the fact that these liquid detergent compositions are contained within a water-soluble or dispersible film, they are characterized by high levels of surfactants and very low concentrations of water.

Preferred water-soluble films are polymers and co-polymers based on polyvinyl alcohol and thermoplastic starch derivatives, wherein polyvinyl alcohol-based polymers are the most often used. Liquid detergent composition that can be held in water-soluble pouches may typically comprise water, solvents, bleaching agents, enzymes, enzyme stabilizing systems, chelating agents, surfactants, neutralizing agents, builders, fillers, anti-redeposition or soil dispersing polymers, fabric caring or enhancing polymers, dye transfer inhibitors, flocculating, deflocculating and thickening agents and fabric softening agents. Such compositions contain preferably less than 0.2% of borate ions but preferably essentially free of borate or perborate.

The level of water in the liquid detergent composition unit dose format is such that the water-soluble polymer forming the pouch does not dissolve as a result of contact with the composition. The level of water in the liquid detergent composition is less than 50% by weight, more particularly less than 20% by weight, still more particularly less than 10% by weight, and may be even as low as 5% by weight of the liquid detergent composition.

Neutralizing agents that may be employed in detergent compositions are preferably selected from an organic bases such as amines, e.g. mono-ethanolamine, tri-ethanolamine, organic Lewis bases, and mixtures thereof, but inorganic bases, such as sodium hydroxide, potassium hydroxide and ammonium hydroxide can also be used. The level of neutralizing agent in the composition is typically from 5 to 15% by weight of the liquid detergent composition.

Preferred solvents are those solvents which do not dissolve a water-soluble polymer forming a pouch. These solvents may have a low polarity or a high polarity. Low polarity solvents include typically linear and/or branched paraffin hydrocarbons. High polarity water-soluble or partially soluble or water miscible solvents include typically alcohols, such as methanol, ethanol, propanol, isopropanol, butanol, diols, such as 1,2-propanediol, 1,3-propanediol, glycerol, sorbitol, 2-amino-2-ethyl propanol, ethers, polyethers, short chain di-, tri- N-substituted alkylamines, short chain alkyl amides, short chain alkyl carboxylic acid lower alkyl esters, ketones, such as short chain alkyl ketones, including acetone. The liquid composition may comprise from 10 to 70% by weight of water-soluble solvents.

All-purpose cleaners comprise typically from 0.1 to 25% by weight or, preferably from 2 to 20% by weight of anionic and non-ionic surfactant, preferably selected from, but not limited to sodium alkyl sulfonates and alkyl ethoxylates; from 1 to 10% by weight, preferably from 2 to 6% by weight soaps, for sample sodium fatty acid carboxylates; from 1 to 15% by weight, preferably from 2 to 10% by weight of alkalinity sources, for example sodium carbonate; from 1 to 10% by weight inorganic builders, for example sodium citrate-citric acid mixture; from 0 to 2% by weight organic builders, for example sodium polycarboxylate; from 0.0001 to 0.5% by weight, preferably from 0.0003 to 0.1% by weight of one or more preservatives; and, up to 5% by weight of one or more water-soluble solvents, citric acid, triethanolamine, sodium hydroxide, potassium hydroxide, ammonia and/or oils.

Shampoos comprise typically from 3% to 25% by weight, for example from 12% to 20% by weight or from 14% to 18% by weight of one or more anionic surfactants; from 0.5% to 20% by weight, for example from 1% to 10% by weight of zwitterionic and/or amphoteric surfactants; from 0% to 10% by weight on non-ionic surfactants; from 20% to 90% by weight of an aqueous phase, comprising optionally water-soluble solvents; from 0.0001 to 0.5% by weight, preferably from 0.0003 to 0.1% by weight of one or more preservatives and optionally benefit agents, such as moisturizers, emollients, thickeners, anti-dandruff agents, hair growth promoting agents, vitamins, nutrients, dyes and hair colorants.

Fabric conditioners or softeners typically comprise nitrogen-containing cationic surfactants having one or two alkyl chains comprising 16 to 22 carbon atoms and optionally hydroxyl groups. The cationic group is preferably a quartenary ammonium, an imidazolium or an amido salt. The quaternary ammonium group has additionally two to three alkyl groups having 1 to 4 carbon or hydroxyalkyl, hydroxyl groups or alkoxy groups, having typically 1 to 10 ethylene oxide moieties, and an anion selected from the group of halides, hydroxides, acetates and methylsulfate. The long alkyl chain is preferably bound to the cationic group via an ester group. Typical examples of such fabric conditioning actives include esterquat (N-methyl-N,N,bis[2-(C16-C18-acetoxy)ethyl)]-N-(2-hydroxyethyl) ammonium methosulfate), diesterquat (N,N,N-trimethyl-N-[1,2-di-(C16-C18-acyloxy)propyl ammonium salts), DEEDMAC (N,N-dimethyl-N,N-bis([2-(-[(1-oxooctadecyl)oxy]ethyl) ammonium chloride, HEQ (N,N,N-trimethyl-N-[(Z)-2-hydroxy-3-[(1-oxo-octadec-9-enyl)oxy]] ammonium chloride, TEAQ (diquaternized methylsulfate salt of the reaction product between C10-C20 staturated and unsaturated fatty acids and triethanoloamine), glycerine-based polyol esterquats, ethyl-tallowalkyl imidazolinium methyl sulphate, ditallowalkyl dimethylammonium methyl sulfate, methyl tallowalkyl amido ethyl tallowalkyl imidazolinium methyl sulfate, b-hydroxyethyl ethylenediamine erivatives, polyammonium and the like, and mixture thereof.

Typical non-ionic surfactants that may be present in fabric conditioners or softeners include, but are not limited to alkyl and alkylbenzyl alcohol alkoxylates or polyalkoxylated carboxylic acids, polyalkoxylated amines, polyalkoxylated glycol or glycerol esters, polyalkoxylated sorbitan esters or alkanoamides.

Hair conditioners typically comprise nitrogen-containing cationic surfactants, such as alkyl quaternary ammonium salts, for example cetrimonium chloride or trimethyl stearyl ammonium chloride; and cationic polymers, such as quaternary nitrogen-substituted cellulose ether derivatives, quaternary nitrogen-containing poly(trialkylaminoethyl methacrylate) derivatives, quaternary nitrogen-containing poly(vinylpyrrolidone), and cyclic cation group-containing polymers such as a diallyl quaternary ammonium homopolymer and a diallyl quaternary ammonium copolymer. Hair conditioners also comprise zwitterionic surfactants and betaines, such as cocamidopropyl betaine; anionic surfactant, such as anionic surface active agent, including carboxylic acid salt-type, sulfonic acid salt-type and sulfuric acid ester salt-type anionic surface active agents, more particularly N-acylaminocarboxylic acid salt-type and ether carboxylic acid salt-type surface active agents; fatty alcohols, such as cetyl alcohol, stearyl alcohol, behenyl alcohol, isostearyl alcohol, octyldodecanol and oleyl alcohol; oils, such as petrolatum and vegetable oils; amodimethicone and silicone polymers, such as methylpolysiloxane, polyoxyethylene-methylpolysiloxane, polyoxypropylene-methylpolyoxysiloxane, poly(oxyethylene, oxypropylene) methylpolysiloxane, methylphenylpolysiloxane, fatty acid-modified polysiloxane, fatty acid alcohol-modified polysiloxane and amino acid-modified polysiloxane; wetting agents such as ethylene glycol, propylene glycol, 1,3-butylene glycol, glycerol and sorbitol; emulsifying agents such as glycerol monostearate and polyoxyethylene sorbitan monolaurate; hydrocarbons such as liquid paraffin, Vaseline and squalene; esters such as isoproidyl myristate and octyldodecyl myristate; cellulose derivatives such as hydroxyethyl cellulose, hydroxypropyl cellulose and carboxymethyl cellulose; and anionic polymers such as acrylic acid-type polymers.

In preferred embodiments of the present invention, the level of shell material in the consumer product is from 0.0005 wt.-% to 0.05 wt.-%, preferably from 0.0010 wt.-% to 0.025 wt.-%, more preferably from 0.0025 to 0.01 wt.-%.

A further aspect of the present invention relates to a use of the encapsulated composition as described herein above for making a consumer product.

Further features and particular advantages of the present invention become apparent from the following examples.

### Example 1—Perfume Compositions

Perfume compositions according to the present invention (Examples A to F) and comparative examples (Examples G and H) were prepared by mixing perfume ingredients according to the formulae provided in Table 1. The ingredients in italic are performance driving perfume ingredients as described herein above.

TABLE 1
Perfume Compositions

| | A | B | C | D | E | F | G | H |
|---|---|---|---|---|---|---|---|---|
| benzyl acetate | 1.00 | | | | | | | 1.00 |
| 3,7-dimethyloct-6-en-1-yl acetate | 10.00 | 4.50 | | | | | | |
| 2-methyl-1-phenylpropan-2-yl acetate | | | 5.00 | | | | | |
| (E)-3,7-dimethylocta-2,6-dien-1-yl acetate | 10.00 | | | | | | | |
| hexyl acetate | | 2.27 | | | | | | |
| 3-methylbutyl acetate | 3.00 | 0.73 | | | | | | |
| 2-(tert-butyl)cyclohexyl acetate | | | 3.00 | | | | | 1.60 |
| (E)-undec-9-enal | 0.20 | 2.27 | 2.50 | | | | | 0.30 |
| decanal | | | | | | | | 3.00 |
| dodecanal | | | | | | | | 1.00 |
| 2-methylundecanal | 0.50 | 2.82 | 4.00 | | | | 1.00 | 6.00 |
| octanal | | | | | | | | 2.00 |
| 1,3,4,5,6,7-hexahydro-.beta.,1,1,5,5- | | | 3.10 | | | | | |
| pentamethyl-2H-2,4a- | | | | | | | | |
| Methanonaphthalene-8-ethanol | | | | | | | | |
| (3aR,5aS,9aS,9bR)-3a,6,6,9a-tetramethyl- | 1.00 | 7.27 | | | 12.50 | | | |
| 2,4,5,5a,7,8,9,9b-octahydro-1H- | | | | | | | | |
| benzo[e][1]benzofuran | | | | | | | | |
| pentyl 2-hydroxybenzoate | 1.00 | | | | | | 4.00 | 7.00 |
| 8-(sec-butyl)-5,6,7,8-tetrahydroquinoline | | | | 0.5 | | | | |
| (ethoxymethoxy)cyclododecane | | | | | | | | 4.00 |
| (1S,2R,5R)-2-ethoxy-2,6,6-trimethyl-9- | 4.53 | | | | | | | |
| methylenebicyclo[3.3.1]nonane | | | | | | | | |
| 2-(2-methylpropyl)quinoline | | | | | | | | |
| (E)-3,7-dimethylocta-2,6-dienal | | 3.64 | | | | | 4.00 | |
| 3,7-dimethyloct-6-enenitrile | | | | | | | 3.00 | |
| (Z)-3-methylcyclotetradec-5-enone | 4.00 | 2.73 | | | | | | |
| 2H-chromen-2-one | | | | | | | | |
| 2,4-dimethylcyclohex-3-ene-1-carbaldehyde | | | 5.00 | | 3.00 | | | |
| prop-2-enyl 3-cyclohexylpropanoate | | 2.27 | | | | | | |
| 3-(4-isopropylphenyl)-2-methylpropanal | | 7.27 | | | | | 4.00 | |
| (E)-1-(2,6,6-trimethylcyclohexa-1,3-dien-1- | 3.30 | | | | | | 0.90 | |
| yl)but-2-en-1-one | | | | | | | | |
| 1-(2,6,6-trimethyl-1-cyclohex-3-enyl)but-2- | | 2.27 | 5.00 | 11.50 | | 12.00 | | 2.00 |
| en-1-one | | | | | | | | |
| methyl 2-(methylamino)benzoate | | | | | | | 4.00 | |
| 2,6-dimethyloct-7-en-2-ol | 8.00 | | | | | | 5.00 | 2.50 |
| 2,6-dimethylheptan-2-ol | | 0.91 | | | | | | |
| (E)-4-((3aS,7aS)-hexahydro-1H-4,7- | 0.25 | 1.82 | | | | | | |
| methanoinden-5(6H)-ylidene)butanal | | | | | | | | |
| (E)-3-methyl-5-(2,2,3-trimethylcyclopent-3- | | | | 1.00 | 5.00 | | | |
| en-1-yl)pent-4-en-2-ol | | | | | | | | |
| ethyl 3-phenylprop-2-enoate | | | | | | | | 0.50 |
| ethyl 2-methylbutanoate | | | | | 3.00 | | | |
| (1s,4s)-1,3,3-trimethyl-2- | | | | | 12.50 | 12.00 | 3.00 | 13.00 |
| oxabicyclo[2.2.2]octane | | | | | | | | |
| 4-allyl-2-methoxyphenol | | | 1.00 | | | | | |
| 3-(4-ethylphenyl)-2,2-dimethylpropanal | | 5.00 | | | | | | |
| (3aR,6S,7aS)-3a,4,5,6,7,7a-hexahydro-1H- | | | 6.50 | | | | 4.00 | 5.00 |
| 4,7-methanoinden-6-yl propanoate | | | | | | | | |
| ethyl 2-(2-methyl-1,3-dioxolan-2-yl)acetate | 4.00 | | | | | | | |
| 4,6,6,7,8,8-hexamethyl-1,3,4,6,7,8- | | | | | | | 5.00 | |
| hexahydrocyclopenta[g]isochromene | | | | | | | | |
| 1-(5,5-dimethylcyclohex-1-en-1-yl)pent-4- | | | 1.20 | | | | 0.10 | |
| en-1-one | | | | | | | | |
| (E)-3,7-dimethylocta-2,6-dien-1-yl acetate | | | 6.65 | | | | | |
| (E)-3,7-dimethylocta-2,6-dien-1-yl but-2- | | | | | | | | 0.00 |
| enoate | | | | | | | | |
| methyl 3-oxo-2-pentylcyclopentaneacetate | 8.00 | | | | | | 10.00 | |
| methyl 7-isopropyl-1,4a-dimethyl- | | | | | 0.50 | | | |
| 1,2,3,4,4a,4b,5,6,7,8,10,10a- | | | | | | | | |
| dodecahydrophenanthrene-1-carboxylate | | | | | | | | |
| (Z)-hex-3-en-1-ol | | 0.45 | | | | | | |
| 7-hydroxy-3,7-dimethyloctanal | 1.00 | | | | | | | |
| 1H-indole | | 0.14 | | | | | | |
| (E)-4-(2,6,6-trimethylcyclohex-1-en-1- | | | | | | 40.00 | 3.00 | |
| yl)but-3-en-2-one | | | | | | | | |
| (E)-4-(2,5,6,6-tetramethylcyclohex-2-en-1- | 2.00 | | | | | | 3.00 | |
| yl)but-3-en-2-one | | | | | | | | |
| 1-(2,3,8,8-tetramethyl-1,2,3,4,5,6,7,8- | 1.00 | | 4.00 | | | | | |
| octahydronaphthalen-2-yl)ethanone | | | | | | | | |
| (Z)-hex-3-en-1-yl 2-methylpropanoate | | 0.91 | | | | | | |
| (E)-2-methoxy-4-(prop-1-en-1-yl)phenol | | | 0.50 | | | | | |
| 3,5,5-trimethylhexyl acetate | | | | | | | 5.00 | |
| (E)-3-methyl-4-(2,6,6-trimethylcyclohex-2- | | | 3.20 | | | | 4.00 | 28.90 |
| en-1-yl)but-3-en-2-one | | | | | | | | |
| (1-methyl-2-((1,2,2- | 2.70 | 1.82 | | 1.00 | 5.00 | | | |
| trimethylbicyclo[3.1.0]hexan-3- | | | | | | | | |
| yl)methyl)cyclopropyl)methanol | | | | | | | | |
| (4Z)-hept-4-en-2-yl 2-hydroxybenzoate | | | | 40.00 | | | | 1.00 |
| 3-(4-(tert-butyl)phenyl)-2-methylpropanal | 1.00 | | 3.10 | | | | 5.00 | |
| 3,7-dimethylocta-1,6-dien-3-yl acetate | | | | | | | 3.00 | |
| (4E)-9-hydroxy-5,9-dimethyl-4-decenal | 2.00 | | | | | | | |
| ethyl 2-methylpentanoate | | 1.82 | 3.00 | | | | | 2.50 |
| ethyl 2-methylbutanoate | | 6.36 | 2.30 | | | | | |
| 2-(2-(4-methylcyclohex-3-en-1- | 1.00 | 5.00 | 1.70 | | | | | 2.00 |
| yl)propyl)cyclopentanone | | | | | | | | |
| 1-(5,5-dimethyl-1-cyclohexenyl)pent-4-en-1- | | | | | 7.00 | | | |
| one | | | | | | | | |
| 2-ethoxynaphthalene | | | 2.00 | | | | 4.00 | |
| 1-(3-methylbenzofuran-2-yl)ethanone | | | | 8.00 | 6.00 | 8.00 | | |
| 2-(2-(dimethylamino)ethoxy)ethyl ethyl | | 0.91 | | | | | | |
| fumarate | | | | | | | | |
| (Z)-non-6-enal | | 0.23 | | | | | | |
| 3-(4-(2-methylpropyl)-2- | | 1.82 | | | 10.00 | | | |
| methylphenyl)propanal | | | | | | | | |
| methyl non-2-ynoate | | 0.45 | 0.35 | | | 0.10 | | |
| prop-2-enyl heptanoate | | 1.82 | | | | | | |
| ORANGE TERPENES | | | | 10.00 | | | 9.00 | |
| 1-(2-naphtalenyl)-ethanone | | | | | | | 3.00 | |
| 2-methyl-4-propyl-1,3-oxathiane | 0.02 | 0.23 | | | | | | |
| 2-ethyl-N-methyl-N-(m-tolyl)butanamide | 0.90 | | | | | | 1.00 | |
| 4-(tert-butyl)cyclohexyl acetate | | | | | | | | 2.00 |
| PATCHOULI ESS DECOL INDONESIE ORPUR | | 4.20 | | 8.00 | | | 5.00 | |
| 5-heptyldihydrofuran-2(3H)-one | 0.80 | | 1.50 | | | | | |
| 2-cyclohexylidene-2-phenylacetonitrile | 1.00 | | 12.50 | | | | | |
| 2-cyclohexylidene-2-(o-tolyl)acetonitrile | | 5.00 | | | | | | |
| (2E,5E)-5,6,7-trimethylocta-2,5-dien-4-one | 2.25 | | | | 0.50 | | | |
| (E)-2-ethyl-4-(2,2,3-trimethylcyclopent-3- | | | | | | | | 5.00 |
| en-1-yl)but-2-en-1-ol | | | | | | | | |
| 2,2,2-trichloro-1-phenylethyl acetate | | | 5.50 | | | | | |
| ROSE OIL | 6.00 | | | | | | | |
| 4-methyl-2-(2-methylprop-1-en-1- | 0.45 | | | | | | | 0.50 |
| yl)tetrahydro-2H-pyran | | | | | | | | |
| 1-methyl-2-(5-methylhex-4-en-2- | 10.00 | 1.73 | | | 4.00 | | | |
| yl)cyclopropylmethanol | | | | | | | | |
| 4-methyl-2-phenyl-3,6-dihydro-2H-pyran | | | 12.50 | | 1.00 | | | |
| ethyl N,S-bis(4-oxo-4-(2,6,6- | | 9.10 | | | | | | |
| trimethylcyclohex-3-en-1-yl)butan-2- | | | | | | | | |
| yl)cysteinate | | | | | | | | |
| 2-(1-(3,3-dimethylcyclohexyl)ethoxy)-2- | 3.00 | 5.60 | | | | | | |
| methylpropyl cyclopropanecarboxylate | | | | | | | | |
| 2-(4-methylphenyl)acetaldehyde | | | | | | 15.00 | | |
| 1-(spiro[4.5]dec-6-en-7-yl)pent-4-en-1-one | | | | 10.00 | | | | |
| 3,7-dimethyloctan-3-ol | | | | | 30.00 | | 5.00 | 8.70 |
| 2,4-dimethylcyclohex-3-enecarbaldehyde | | 3.64 | | | | | | |
| (3E,5Z)-undeca-1,3,5-triene | | | 0.80 | 10.00 | | | | 0.50 |
| (E)-4-methyldec-3-en-5-ol | 1.00 | 3.00 | 4.10 | | | 12.90 | 2.00 | |
| (Z)-cyclohexadec-5-enone | 5.00 | | | | | | | |
| 2-(2,4-dimethylcyclohexyl)pyridine | 0.10 | | | | | | | |
| Total % performance markers | 9.27 | 9.10 | 25.95 | 41.00 | 12.50 | 20.10 | 1.00 | 3.30 |
| # performance markers | 8 | 7 | 8 | 6 | 4 | 4 | 2 | 4 |

### Example 2—Preparation of Melamine-Formaldehyde Microcapsules

Cationic melamine-formaldehyde microcapsules comprising the fragrance compositions shown in Table 1 were prepared by performing the procedure as described in Example 1 of WO 2016/207180 A1, in order to obtain slurries of microcapsules having a volume median diameter Dv(50) of 10±2 m. The solid content of the slurry was 43±3 wt.-% and the level of shell material in the slurry was 3 wt.-%.

### Example 3—Olfactive Performance

The slurries of core-shell microcapsules obtained in Example 2 were incorporated into a model fabric care conditioner having the composition shown in Table 2. The level of slurry was 0.2 wt.-% based on the total weight of the conditioner. The pH of the conditioner was 3.

TABLE 2
Conditioner Composition

| | | | Quantity |
|---|---|---|---|
| Ingredient | Supplier | INCI name | [wt.-%] |
| Calcium Chloride | VWR | Calcium chloride | 0.5 |
| Stepantex SP-90 | Stepan | Dialkylester Ammonium | 11.1 |
| | | Methosulfate | |
| Eumulgin CO-40 | BASF | PEG-40 Hydrogenated | 1.0 |
| | | Castor Oil | |
| Sodium benzoate | VWR | Sodium benzoate | 0.3 |
| Citric acid | VWR | Citric acid | q.s. pH 3 |
| Encapsulated | | | 0.2 |
| composition (slurry) | | | |
| Water | | | q.s. 100 |

Terry towels were submitted to a rinse cycle in a front-loaded washing machine. The amount of conditioner was 35 g for a towel load of 1.0 kg and the total volume of water was 20 L. Olfactive evaluations were performed using both freshly prepared conditioner and after aging the conditioners for one month at 37° C.

For this evaluation, the terry toweling was handled carefully in order to minimize the risk of breaking the microcapsules mechanically. The odor intensity was assessed on the wet terry toweling just taken out of the washing machine, without breaking the microcapsules. The pre-rub and post-rub olfactive evaluation was performed after line drying the terry toweling for 24 hours at room temperature. The olfactive performance (intensity) was assessed by a panel of 4 experts rating on a scale of 1-5 (1=barely noticeable, 2=weak, 3=medium, 4=strong and 5=very strong). In such evaluation, the post-rub score measures the additional impact induced by microcapsule breakage, compared to the pre-rub intensity.

Any sample showing an evaluation score higher than 2 at all three assessment points (wet towel, dry towel pre-rub and post-rub) was considered as passing the performance requirements.

The results are reported in Table 3.

TABLE 3
Fulfilment of the Olfactive Performance Requirements

| | Compliance Performance |
|---|---|
| Sample | Requirements |
| A | Passed |
| B | Passed |
| C | Passed |
| D | Passed |
| E | Passed |
| F | Passed |
| G | Failed |
| H | Failed |

As apparent from the results of Table 3, the encapsulated compositions comprising the encapsulated fragrance compositions A to F, according to the present invention, perform at all stages of the olfactive assessment process, whereas conventional fragrance compositions G and H do not.

1. An encapsulated composition comprising a plurality of core-shell microcapsules, the core-shell microcapsules comprising a core and a shell surrounding the core, the core comprising a fragrance composition, wherein the fragrance composition comprises at least 5 wt.-%, based on the total weight of the fragrance composition, of at least four performance driving perfume ingredients selected from the group consisting of 2,6,10-trimethylundec-9-enal; 2-methyldecanal; undec-10-enal; (E)-undec-9-enal; 3,8,8,11a-tetramethyldodecahydro-1H-3,5a-epoxynaphtho[2,1-c]oxepine; 1,3,4,5,6,7-hexahydro-β,1,1,5,5-pentamethyl-2H-2,4a-methanonaphthalene-8-ethanol; decahydro-2,2,6,6,7,8,8-heptamethyl indenofuran; (4aR,5R,7aS,9R)-Octahydro-2,2,5,8,8,9a-hexamethyl-4H-4a,9-methanoazuleno[5,6-d]-1,3-dioxole; 7-isopentyl-2H-benzo[b][1,4]dioxepin-3(4H)-one; 8-(sec-butyl)-5,6,7,8-tetrahydroquinoline; 2-(2-methylpropyl)quinoline; 5-isopropyl-2-methylphenol; 5-tert-butyl-2-methyl-5-propyl-2H-furan; (E)-1-(2,6,6-trimethylcyclohex-2-en-1-yl)hepta-1,6-dien-3-one; (Z)-non-6-enal; (4S)-4,7,7-trimethyl-6-thiabicyclo[3.2.1]octane; 1-methoxy-4-methyl-benzene; 4-isopropylbenzonitrile; 4-isopropylbenzaldehyde; (E)-1-(2,6,6-trimethylcyclohexa-1,3-dien-1-yl)but-2-en-1-one; 1-(2,6,6-trimethyl-1-cyclohex-3-enyl)but-2-en-1-one; (E)-dec-2-enal; (E)-dec-4-enal; 9-decenal; (E)-dodec-2-enal; (E)-4-((3aS,7aS)-hexahydro-1H-4,7-methanoinden-5(6H)-ylidene)butanal; ethyl cyclohexyl carboxylate; methyl 2,4-dihydroxy-3,6-dimethylbenzoate; (E)-undec-9-enenitrile; methyl oct-2-ynoate; 1-(5,5-dimethylcyclohex-1-en-1-yl)pent-4-en-1-one; 6-butan-2-yl-quinoline; (E)-2-methoxy-4-(prop-1-en-1-yl)phenol; 6-isopropyl-quinoline; (1-methyl-2-((1,2,2-trimethylbicyclo[3.1.0]hexan-3-yl)methyl)cyclo-propyl)methanol; bicyclo[2.2.2]oct-5-ene-2-carboxaldehyde; methyl non-2-ynoate; 10-isopropyl-2,7-dimethyl-1-oxaspiro[4.5]deca-3,6-diene; (E)-methyl non-2-enoate; 1-(3-methylbenzofuran-2-yl)ethanone; (2E,6Z)-nona-2,6-dienal; (2Z,6E)-nona-2,6-dien-1-ol; (Z)-non-6-enal; 2-methyl-4-propyl-1,3-oxathiane; 2-methyl-4-methylene-6-phenyltetrahydro-2H-pyran; 2-cyclohexylhepta-1,6-dien-3-one; (2E,5E)-5,6,7-trimethylocta-2,5-dien-4-one; 6-(sec-butyl)quinoline; dec-9-en-1-ol; 4-methyl-2-(2-methylprop-1-en-1-yl)tetrahydro-2H-pyran; 4-methyl-2-phenyl-3,6-dihydro-2H-pyran; 2,3,3-trimethyl-2,3-dihydro-1H-inden-1-one; 2,6,6-trimethylcyclohexa-1,3-dienecarbaldehyde; 1-(spiro[4.5]dec-6-en-7-yl)pent-4-en-1-one; 2-(p-tolyl)-acetaldehyde; 1-(cyclopropylmethyl)-4-methoxybenzene; (E)-undec-2-enal; (E)-hex-2-enal; (E)-tridec-2-enenitrile and (3E,5Z)-undeca-1,3,5-triene.

2. The encapsulated composition according to claim 1, wherein each of the performance driving perfume ingredients is present at a concentration equal to or less than the following maximum concentrations:
2,6,10-trimethylundec-9-enal: 1 wt.-%
2-methyldecanal: 1 wt.-%
undec-10-enal: 3 wt.-%
(E)-undec-9-enal: 5 wt.-%
3,8,8,11a-tetramethyldodecahydro-1H-3,5a-epoxynaphtho[2,1-c]oxepine: 10 wt.-%
1,3,4,5,6,7-hexahydro-β,1,1,5,5-pentamethyl-2H-2,4a-methanonaphthalene-8-ethanol: 5 wt.-%
decahydro-2,2,6,6,7,8,8-heptamethyl indenofuran: 1 wt.-%
(4aR,5R,7aS,9R)-Octahydro-2,2,5,8,8,9a-hexamethyl-4H-4a,9-methanoazuleno[5,6-d]-1,3-dioxole: 0.25 wt.-%
7-isopentyl-2H-benzo[b][1,4]dioxepin-3(4H)-one: wt.-%
8-(sec-butyl)-5,6,7,8-tetrahydroquinoline: 1 wt.-%
2-(2-methylpropyl)quinoline: 1 wt.-%
5-isopropyl-2-methylphenol: 1 wt.-%
5-tert-butyl-2-methyl-5-propyl-2H-furan: 1 wt.-%
(E)-1-(2,6,6-trimethylcyclohex-2-en-1-yl)hepta-1,6-dien-3-one: 1 wt.-%
(4S)-4,7,7-trimethyl-6-thiabicyclo[3.2.1]octane: 0.5 wt.-%
1-methoxy-4-methylbenzene: 1.5 wt.-%
4-isopropylbenzonitrile: 0.5 wt.-%
4-isopropylbenzaldehyde: 1.5 wt.-%
(E)-1-(2,6,6-trimethylcyclohexa-1,3-dien-1-yl)but-2-en-1-one: 5 wt.-%
1-(2,6,6-trimethyl-1-cyclohex-3-enyl)but-2-en-1-one: 15 wt.-%
(E)-dec-2-enal: 1 wt.-%
(E)-dec-4-enal: 1 wt.-%
9-decenal: 0.5 wt.-%
(E)-dodec-2-enal: 0.5 wt.-%
(E)-4-((3aS,7aS)-hexahydro-1H-4,7-methanoinden-5(6H)-ylidene)butanal: wt.-%
ethyl cyclohexyl carboxylate: 0.5 wt.-%
methyl 2,4-dihydroxy-3,6-dimethylbenzoate: 0.5 wt.-%
(E)-undec-9-enenitrile: 1 wt.-%
methyl oct-2-ynoate: 1 wt.-%
1-(5,5-dimethylcyclohex-1-en-1-yl)pent-4-en-1-one: 10 wt.-%
6-butan-2-yl-quinoline: 1 wt.-%
(E)-2-methoxy-4-(prop-1-en-1-yl)phenol: 1.5 wt.-%
6-isopropylquinoline: 1 wt.-%
(1-methyl-2-((1,2,2-trimethylbicyclo[3.1.0]hexan-3-yl)methyl)cyclopropyl)methanol: 10 wt.-%
bicyclo[2.2.2]oct-5-ene-2-carboxaldehyde: 0.5 wt.-%
methyl non-2-ynoate: 1 wt.-%
10-isopropyl-2,7-dimethyl-1-oxaspiro[4.5]deca-3,6-diene: 1.5 wt.-%
(E)-methyl non-2-enoate: 1 wt.-%
1-(3-methylbenzofuran-2-yl)ethanone: 10 wt.-%
(2E,6Z)-nona-2,6-dienal: 0.5 wt.-%
(2Z,6E)-2,6-nonadien-1-ol: 0.5 wt.-%
(Z)-non-6-enal: 0.5 wt.-%
2-methyl-4-propyl-1,3-oxathiane: wt.-%
2-methyl-4-methylene-6-phenyltetrahydro-2H-pyran: 5 wt.-%
2-cyclohexylhepta-1,6-dien-3-one: 0.5 wt.-%
(2E,5E)-5,6,7-trimethylocta-2,5-dien-4-one: 3 wt.-%
6-(sec-butyl)quinoline: 1.5 wt.-%
dec-9-en-1-ol: 2 wt.-%
4-methyl-2-(2-methylprop-1-en-1-yl)tetrahydro-2H-pyran: 2 wt.-%
4-methyl-2-phenyl-3,6-dihydro-2H-pyran: 15 wt.-%
2,3,3-trimethyl-1-indanone: 1 wt.-%
2,6,6-trimethylcyclohexa-1,3-dienecarbaldehyde: 0.5 wt.-%
1-(spiro[4.5]dec-6-en-7-yl)pent-4-en-1-one: 1.5 wt.-%
2-(p-tolyl)acetaldehyde: 20 wt.-%
1-(cyclopropylmethyl)-4-methoxybenzene: 1 wt.-%
(E)-undec-2-enal: 0.5 wt.-%
(E)-hex-2-enal: 0.5 wt.-%
(E)-tridec-2-enenitrile: 15 wt.-%
(3E,5Z)-undeca-1,3,5-triene: 15 wt.-%

3. The encapsulated composition according to claim 1, wherein the performance driving perfume ingredients are present at a concentration equal to or higher than the minimum concentration of 0.001 wt.-%.

4. The encapsulated composition according to claim 1, wherein the performance driving perfume ingredients are selected from the group consisting of 2,6,10-trimethylundec-9-enal; 2-methyldecanal; undec-10-enal; (E)-undec-9-enal; 3,8,8,11a-tetramethyldodecahydro-1H-3,5a-epoxynaphtho[2,1-c]oxepine; 5-isopropyl-2-methylphenol; (E)-1-(2,6,6-trimethylcyclohex-2-en-1-yl)hepta-1,6-dien-3-one; (Z)-non-6-enal; 1-methoxy-4-methylbenzene; 4-isopropylbenzonitrile; 4-isopropylbenzaldehyde; (E)-1-(2,6,6-trimethylcyclohexa-1,3-dien-1-yl)but-2-en-1-one; (E)-dec-2-enal; (E)-dec-4-enal; 9-decenal; (E)-dodec-2-enal; ethyl cyclohexyl carboxylate; methyl 2,4-dihydroxy-3,6-dimethylbenzoate; (E)-undec-9-enenitrile; 1-(5,5-dimethylcyclohex-1-en-1-yl)pent-4-en-1-one; (E)-2-methoxy-4-(prop-1-en-1-yl)phenol; methyl non-2-ynoate; (E)-methyl non-2-enoate; 1-(3-methylbenzofuran-2-yl)ethanone; (2E,6Z)-nona-2,6-dienal; (2Z,6E)-2,6-nonadien-1-ol; (Z)-non-6-enal; 2-cyclohexylhepta-1,6-dien-3-one; (2E,5E)-5,6,7-trimethylocta-2,5-dien-4-one; dec-9-en-1-ol; 4-methyl-2-(2-methylprop-1-en-1-yl)tetrahydro-2H-pyran; 4-methyl-2-phenyl-3,6-dihydro-2H-pyran; 2,6,6-trimethylcyclohexa-1,3-dienecarbaldehyde; 1-(cyclopropylmethyl)-4-methoxybenzene; (E)-undec-2-enal; (E)-hex-2-enal; (E)-tridec-2-enenitrile and (3E,5Z)-undeca-1,3,5-triene.

5. The encapsulated composition according to claim 1, comprising at least one further perfume ingredient.

6. The encapsulated composition according to claim 5, wherein the at least one further perfume ingredient is biodegradable.

7. The encapsulated composition according to claim 1, wherein the shell of the core-shell microcapsules comprises a melamine-formaldehyde polymer.

8. The encapsulated composition according to claim 1, wherein the shell of the core-shell microcapsules comprises a polyurea or polyurethane polymer.

9. The encapsulated composition according to claim 1, wherein the shell of the core-shell microcapsule comprises, in polymerized form, one or more monoethylenically unsaturated and/or polyethylenically unsaturated monomer(s).

10. The encapsulated composition according to claim 1, wherein the volume median diameter Dv(50) of the microcapsules is from 1 to 50 μm.

11. The encapsulated composition according to claim 1, in form of a slurry wherein the core-shell microcapsules are dispersed or suspended in an aqueous phase.

12. The encapsulated composition according to claim 11, wherein the slurry has a solid content of from 20 wt.-% to 60 wt.-%.

13. The encapsulated composition according to claim 11, wherein the slurry comprises from 1 wt.-% to 10 wt.-% of shell material.

14. The encapsulated composition according to claim 1, wherein the level of shell material in the core-shell microcapsules is from 2 wt.-% to 20 wt.-% based on the total weight of the core-shell microcapsules.

15. A consumer product comprising an encapsulated composition according to claim 1.

16. The consumer product according to claim 15, selected from the group consisting of laundry care detergents, laundry care conditioners, fabric refreshers, personal care cleansing compositions, such as shampoos, bath and shower gels, liquid soaps, soap bars, personal care conditioning composition, such as hair care conditioners, bath and shower lotions, deodorant compositions, antiperspirant compositions, home care compositions, such as hard surface cleaners, and heavy duty detergents, and fragranced products comprising ethanol.

17. The consumer product according to claim 15, wherein the level of shell material in the consumer product is from 0.0005 wt.-% to 0.05 wt.-% based on the total weight of the consumer product.

18. The consumer product according to claim 15, wherein the level of microcapsules in the consumer product is from 0.002 wt.-% to 0.12% based on the total weight of the consumer product.

19. A method of making a consumer product, comprising including the encapsulated composition of claim 1 within the consumer product.

20. A consumer product comprising an encapsulated composition according to claim 15, wherein the consumer product is a fabric care product, a home care product or a personal care product.
